(19) United States
(12) Patent Application Publication
(10) Pub. No.: US 2015/0090020 A1
(43) Pub. Date: Apr. 2, 2015

(54) METHOD AND SYSTEM FOR DIAGNOSING DETERIORATION OF EXHAUST EMISSION CONTROL CATALYST

(71) Applicant: Mazda Motor Corporation, Hiroshima (JP)

(72) Inventors: Hiroyuki Takita, Hiroshima-shi (JP); Mitsuharu Kaura, Higashihiroshima-shi (JP); Susumu Takano, Hiroshima-shi (JP); Yosuke Honda, Higashihiroshima-shi (JP); Hidekazu Kashiro, Hiroshima-shi (JP)

(21) Appl. No.: 14/485,308

(22) Filed: Sep. 12, 2014

(30) Foreign Application Priority Data
Sep. 30, 2013 (JP) 2013-204479

(51) Int. Cl. F01N 11/00; G01M 15/10

(52) U.S. Cl. CPC F01N 11/002; G01M 15/102; F01N 2550/02
USPC 73/114.75; 422/119

(57) ABSTRACT

A deterioration diagnosing system for an exhaust emission control catalyst of an engine is provided. The catalyst includes an HC adsorbing part and an oxidation catalyst part. The system includes an actual exhaust-emission-control-catalyst temperature parameter detecting module for detecting a parameter correlating with an actual exhaust-emission-control-catalyst temperature. The catalyst also includes a deterioration determining module for receiving a detection value from the actual exhaust-emission-control-catalyst temperature parameter detecting module when predetermined diagnosis executing conditions are met, and determining that the exhaust emission control catalyst is deteriorated when the detection value is smaller than a predetermined diagnostic temperature parameter threshold. The catalyst also includes an HC discharge amount calculating module for calculating an amount of discharging HC from the HC adsorbing part. The catalyst also includes a false deterioration determination preventing module for receiving a signal from the HC discharge amount calculating module and preventing false determination of the deterioration determining module.

### BACKGROUND

The present invention relates to method and system for diagnosing deterioration of an exhaust emission control catalyst, which is provided in an exhaust passage of an engine, and particularly of an oxidation catalyst, which includes an HC adsorbing part.

For the purpose of purifying NOR (nitrogen oxide), HC (carbon hydride), and CO (carbon monoxide) contained in exhaust gas discharged from engines (e.g., diesel engines, gasoline engines), exhaust emission control catalysts (e.g., three-way catalysts, oxidation catalysts, NOR storage and reduction catalysts) are generally provided in exhaust passages of the engines. When deterioration of the exhaust emission control catalyst progresses, NOR, HC, and CO are discharged outside the vehicle without being purified, and therefore, it becomes necessary to detect the deterioration of the exhaust emission control catalyst. Among such exhaust emission control catalysts, with an exhaust emission control catalyst including an oxidation catalyst part for purifying HC by oxidization, oxidative reaction heat which is generated when HC is oxidized becomes weaker as the deterioration progresses, and thus, the deterioration of the oxidation catalyst part can be determined by detecting the weakening of the oxidative reaction heat. For example, JP2010-112220A discloses a deterioration diagnosing system of an exhaust emission control catalyst including such an oxidation catalyst part.

With the method disclosed in JP2010-112220A, an exhaust heat rate (obtained by multiplying an exhaust gas temperature by an exhaust gas flow rate) is calculated at a part of the exhaust passage on an entrance side of the exhaust emission control catalyst and a part of the exhaust passage on an exit side of the exhaust emission control catalyst, an oxidative reaction heat rate in the exhaust emission control catalyst is calculated based on the difference in exhaust heat rate between the entrance side and the exit side, and when an integrated value of the oxidative reaction heat rates in a predetermined period of time is smaller than a predetermined threshold for deterioration diagnosis, the exhaust emission control catalyst is determined as deteriorated.

In other words, in JP2010-112220A, in the deterioration diagnosis based on the oxidative reaction heat in the exhaust emission control catalyst, since the oxidative reaction amount changes due to the change of the exhaust gas flow rate and the detected oxidative reaction heat varies, in order to suppress a false deterioration determination of the exhaust emission control catalyst caused by the variation, the oxidative reaction heat rate calculated based on the exhaust gas flow rate is used as a diagnostic parameter.

Meanwhile, due to the recent enforcement of exhaust gas regulation, introduction of exhaust emission control catalysts including HC adsorbing parts that have a function to adsorb HC discharged from the engine at a low temperature and discharge the adsorbed HC at a high temperature have been discussed. With such an exhaust emission control catalyst including the HC adsorbing part, HC can temporarily be adsorbed when the exhaust emission control catalyst is not activated and cannot sufficiently purify HC (e.g., in cold start), and then the adsorbed HC can be discharged and purified after the exhaust emission catalyst is activated. Therefore, HC discharged outside the vehicle can be reduced.

However, with such an exhaust emission control catalyst including the HC adsorbing part, when diagnosing the deterioration based on the oxidative reaction heat of the exhaust emission control catalyst, since the oxidative reaction heat increases by the HC discharged from the HC adsorbing part, there is a possibility that the deterioration of the exhaust emission control catalyst is falsely determined. Specifically, when HC is discharged from the HC adsorbing part, since the HC discharged from the HC adsorbing part is oxidized by the oxidation catalyst part in addition to HC and CO discharged from the engine, the detected oxidative reaction heat includes the oxidative reaction heat produced by the HC discharged from the HC adsorbing part. Therefore, when HC is discharged from the HC adsorbing part, even if the exhaust emission control catalyst is deteriorated, since a high oxidative reaction heat is detected, there is a possibility that it is falsely determined that the exhaust emission control catalyst is not deteriorated. Moreover, the oxidative reaction heat to be added by the HC discharged from the HC adsorbing part included in the detected oxidative reaction heat is not stable and varies according to an engine operating state and a state of the exhaust emission control catalyst and the like. Therefore, if the oxidative reaction heat produced by the HC discharged from the HC adsorbing part is not detected accurately, there is a possibility that the deterioration of the exhaust emission control catalyst is falsely determined.

In such a deterioration diagnosis of the exhaust emission control catalyst including the HC adsorbing part, even if the deterioration diagnostic accuracy is improved by using the method in JP2010-112220A, the false deterioration determination due to the oxidative reaction heat added by the HC discharged from the HC adsorbing part cannot be prevented. Therefore, the possibility that the deterioration of the exhaust emission control catalyst is falsely determined still remains.

### SUMMARY

The present invention is made in view of the above situations and aims to accurately determine deterioration of an exhaust emission control catalyst, which includes an HC adsorbing part.

According to one aspect of the invention, a deterioration diagnosing system for an exhaust emission control catalyst of an engine is provided. The exhaust emission control catalyst includes an HC adsorbing part and an oxidation catalyst part. The HC adsorbing part is disposed in an exhaust passage of the engine, adsorbs HC within exhaust gas when a temperature of the HC adsorbing part is lower than an HC dischargeable temperature, and discharges the adsorbed HC when the temperature of the HC adsorbing part is higher than the HC dischargeable temperature. The oxidation catalyst part purifies, by oxidation, the HC discharged from the HC adsorbing part and the HC within the exhaust gas under a high temperature. The deterioration diagnosing system includes an actual exhaust-emission-control-catalyst temperature parameter detecting module, a deterioration determining module, an HC discharge amount calculating module, and a false deterioration determination preventing module. The actual exhaust-emission-control-catalyst temperature parameter detecting module detects a parameter correlating with an actual temperature of the exhaust emission control catalyst. The deterioration determining module receives a detection value from the actual exhaust-emission-control-catalyst temperature parameter detecting module when predetermined diagnosis executing conditions are met, and determines that the exhaust emission control catalyst is deteriorated when the detection value is smaller than a predetermined diagnostic temperature parameter threshold. The HC discharge amount calculating module calculates an amount of discharging HC from the HC adsorbing part. The false deterioration determination preventing module receives a signal from the HC discharge amount calculating module and prevents false determination of the deterioration determining module that is induced by an increase of the actual exhaust-emission-control-catalyst temperature parameter associated with an increase of the HC discharge amount.

With the above configuration, the false deterioration determination preventing module is provided, which calculates by using the HC discharge amount calculating module, the HC discharge amount that varies depending on an operating state of the engine and a state of the HC adsorbing part, and based on the calculated HC discharge amount, prevents the false determination of the deterioration of the exhaust emission control catalyst that is induced by the increase of the actual exhaust-emission-control-catalyst temperature parameter. Thus, the false deterioration determination of the exhaust emission control catalyst that is induced by the addition of an oxidative reaction heat produced by HC discharged from the HC adsorbing part can be prevented. Such a false determination preventing module can exclude the influence of the addition of the oxidative reaction heat produced by HC discharged from the HC adsorbing part by, for example, limiting the deterioration determination when the HC discharge amount is large or changing the diagnostic temperature parameter threshold to be higher as the HC discharge amount is larger so as to consider that the oxidative reaction heat added by the HC discharged from the HC adsorbing part becomes higher as the HC discharge amount is larger.

Further, the HC discharge amount calculating module may include a total HC adsorb amount calculating module for calculating a total amount of HC adsorbed by the HC adsorbing part, and calculate the HC discharge amount to be larger as the total HC adsorb amount calculated by the total HC adsorb amount calculating module is larger.

To prevent the false deterioration determination of the exhaust emission control catalyst due to HC discharged from the HC adsorbing part, it is important to calculate the HC discharge amount accurately. The HC discharge amount correlates with the total HC adsorb amount and the HC discharge amount becomes larger as the total HC adsorb amount is larger. Thus, in the above configuration, by calculating the HC discharge amount larger as the calculated total HC adsorb amount is larger, the HC discharge amount is calculated more accurately. Therefore, a more accurate oxidative reaction heat added by the HC discharged from the HC adsorbing part is taken into consideration, and the false deterioration determination of the exhaust emission control catalyst due to the HC discharged from the HC adsorbing part can be prevented more surely.

Further, the HC discharge amount calculating module may include an HC adsorbing part temperature detecting module for detecting a temperature of the HC adsorbing part, and calculate the HC discharge amount to be larger as the HC adsorbing part temperature detected by the HC adsorbing part temperature detecting module is higher.

The HC discharge amount correlates with the HC adsorbing part temperature, and as the HC adsorbing part temperature is higher, the adsorbed HC and the HC adsorbing part becomes easy to be uncoupled, and thus, the HC discharge amount per unit time becomes larger. Thus, in the above configuration, by calculating the HC discharge amount to be larger as the HC adsorbing part temperature is higher, since the HC discharge amount can be calculated more accurately, the more accurate oxidative reaction heat added by the HC discharged from the HC adsorbing part is taken into consideration, and the false deterioration determination of the exhaust emission control catalyst due to the HC discharged from the HC adsorbing part can be prevented more surely. The HC adsorbing part temperature may be obtained by detecting the actual temperature of the HC adsorbing part or may be estimated based on, for example, the exhaust gas temperature at the position upstream of the exhaust emission control catalyst or the exhaust gas temperature at the position downstream of the exhaust emission control catalyst which correlates with the HC adsorbing part temperature. Moreover, to simplify the control, the HC adsorbing part temperature may be substituted by, for example, the exhaust gas temperature downstream of the exhaust emission control catalyst correlating with the HC adsorbing part temperature.

Further, the HC discharge amount calculating module may include an exhaust gas pressure detecting module for detecting a pressure of the exhaust gas discharged from the engine, and calculate the HC discharge amount to be larger as the exhaust gas pressure detected by the exhaust gas pressure detecting module is lower.

The HC discharge amount correlates with the exhaust gas pressure. That is, since the adsorption of HC is achieved by the HC adsorbing part composed of a crystal (e.g., zeolite) being chemically coupled to HC and the HC is discharged when it is uncoupled and the temperature reaches a level where it can be desorbed (boiling point), when the exhaust gas pressure is low and the pressure at the HC adsorbing part is low, the boiling point at which HC can be desorbed falls and it becomes easy to discharge HC. Thereby, the HC discharge amount per unit time becomes larger. Thus, in the above configuration, by calculating the HC discharge amount to be higher as the exhaust gas pressure is smaller, the HC discharge amount can be calculated more accurately. Therefore, the more accurate oxidative reaction heat added by the HC discharged from the HC adsorbing part is taken into consideration, and the false deterioration determination of the exhaust emission control catalyst due to the HC discharged from the HC adsorbing part can be prevented more surely.

Further, the total HC adsorb amount calculating module may include an engine discharge HC amount calculating module for calculating an HC amount discharged from the engine per unit time, an HC adsorbable ratio calculating module for calculating an HC adsorbable ratio in the HC adsorbing part, an HC adsorb amount calculating module for calculating an HC adsorb amount per unit time based on the HC amount discharged from the engine calculated by the engine discharge HC amount calculating module and the HC adsorbable ratio, and an HC adsorb amount integrating module for integrating the HC adsorb amounts calculated by the HC adsorb amount calculating module. The HC discharge amount calculating module may calculate the integrated value obtained by the HC adsorb amount integrating module as a total amount of HC adsorbed by the HC adsorbing part.

The HC adsorb amount per unit time varies based on the engine discharge HC amount that varies depending on the operating state of the engine and the HC adsorbable ratio that varies due to the states of the engine and the exhaust emission control catalyst. Thus, in the above configuration, by calculating the HC adsorb amount per unit time based on the engine discharge HC amount and the HC adsorbable ratio, and calculating the total HC adsorb amount by integrating the calculated HC adsorb amount per unit time, the total HC discharge amount can be calculated more accurately. Accordingly, the HC discharge amount is calculated more accurately; therefore, the more accurate oxidative reaction heat added by the HC discharged from the HC adsorbing part is taken into consideration, and the false deterioration determination of the exhaust emission control catalyst due to the HC discharged from the HC adsorbing part can be prevented more surely.

Further, the HC adsorbable ratio calculating module may calculate the HC adsorbable ratio to be higher as the total HC adsorb amount calculated by the total HC adsorb amount calculating module is smaller.

The HC adsorbable ratio correlates with the total HC adsorb amount. That is, since the adsorption of HC is performed in an area of the HC adsorbing part where HC is not yet adsorbed, when the total HC adsorb amount is large, the area where HC is not adsorbed becomes small, and the HC adsorbable ratio becomes low. Thus, in the above configuration, by calculating the HC adsorbable ratio to be higher as the total HC adsorb amount is smaller, the HC adsorbable ratio can be calculated more accurately. Accordingly, the total HC adsorb amount and the HC discharge amount can be calculated more accurately; therefore, the more accurate oxidative reaction heat added by the HC discharged from the HC adsorbing part is taken into consideration, and the false deterioration determination of the exhaust emission control catalyst due to the HC discharged from the HC adsorbing part can be prevented more surely.

Further, the HC adsorbable ratio calculating module may include an HC adsorbing part temperature detecting module for detecting a temperature of the HC adsorbing part, and calculate the HC adsorbable ratio to be higher as the HC adsorbing part temperature detected by the HC adsorbing part temperature detecting module is lower.

The HC adsorbable ratio correlates with the HC adsorbing part temperature. That is, as the HC adsorbing part temperature becomes higher, since HC becomes easier to be discharged as described above, HC becomes difficult to be adsorbed and the HC adsorbable ratio becomes lower. Thus, in the above configuration, by calculating the HC adsorbable ratio to be higher as the HC adsorbing part temperature is lower, the HC adsorbable ratio can be calculated more accurately. Accordingly, the total HC adsorb amount and the HC discharge amount can be calculated more accurately; therefore, the more accurate oxidative reaction heat added by the HC discharged from the HC adsorbing part is taken into consideration, and the false deterioration determination of the exhaust emission control catalyst due to the HC discharged from the HC adsorbing part can be prevented more surely.

Further, the HC adsorbable ratio calculating module may include an exhaust gas flow rate detecting module for detecting a flow rate of the exhaust gas discharged from the engine, and calculate the HC adsorbable ratio to be higher as the exhaust gas flow rate detected by the exhaust gas flow rate detecting module is smaller.

The HC adsorbable ratio correlates with the exhaust gas flow rate. That is, as the exhaust gas flow rate becomes higher, since a flow speed of the exhaust gas becomes higher and the required time for HC discharged from the engine to pass through the HC adsorbing part becomes short, the HC adsorbable ratio becomes lower. Thus, in the above configuration, by calculating the HC adsorbable ratio to be higher as the exhaust gas flow rate is lower, the HC adsorbable ratio can be calculated more accurately. Accordingly, the total HC adsorb amount and HC discharge amount can be calculated more accurately; therefore, the more accurate oxidative reaction heat added by the HC discharged from the HC adsorbing part is taken into consideration, and the false deterioration determination of the exhaust emission control catalyst due to the HC discharged from the HC adsorbing part can be prevented more surely.

Further, the HC adsorbable ratio calculating module may include an exhaust gas pressure detecting module for detecting a pressure of the exhaust gas discharged from the engine, and calculate the HC adsorbable ratio to be higher as the exhaust gas pressure detected by the exhaust gas pressure detecting module is larger.

The HC adsorbable ratio correlates with the exhaust gas pressure. That is, as the exhaust gas pressure becomes higher, the pressure in the adsorbing part becomes higher and, thus, the boiling point at which HC is desorbed rises and HC becomes difficult to be discharged, which allows HC to be adsorbed more easily. Thereby, the HC adsorbable ratio becomes higher. Thus, in the above configuration, by calculating the HC adsorbable ratio to be higher as the exhaust gas pressure is higher, the HC adsorbable ratio can be calculated more accurately. Accordingly, the total HC adsorb amount and HC discharge amount can be calculated more accurately; therefore, the more accurate oxidative reaction heat added by the HC discharged from the HC adsorbing part is taken into consideration, and the false deterioration determination of the exhaust emission control catalyst due to the HC discharged from the HC adsorbing part can be prevented more surely.

Further, the total HC adsorb amount calculating module may include a total HC adsorb amount memory for storing the total HC adsorb amount calculated immediately before the engine is stopped, and set the stored value in the total HC adsorb amount memory as the total HC adsorb amount when the engine is restarted.

When the engine is stopped before reaching the temperature at which HC is discharged, HC remains adsorbed by the HC adsorbing part. Thus, in the above configuration, the HC adsorb amount before the engine is stopped is stored, and when the engine is started next time, a current total HC adsorb amount is calculated while the HC which is adsorbed before the engine is stopped is considered still remaining. Therefore, an error of the total HC adsorb calculation value is reduced.

Further, the false deterioration determination preventing module may include a diagnostic temperature parameter threshold setting module for setting the predetermined diagnostic temperature parameter threshold, and control the diagnostic temperature parameter threshold setting module to change the predetermined diagnostic temperature parameter threshold to be higher as the HC discharge amount calculated by the HC discharge amount calculating module is larger.

In the above configuration, since the diagnostic temperature parameter threshold is set so that the threshold changes to be higher as the HC discharge amount is larger, the oxidative reaction heat added by the HC discharged from the HC adsorbing part is taken into consideration, and the false deterioration determination of the exhaust emission control catalyst due to the HC discharged from the HC adsorbing part can be prevented.

Further, the HC discharge amount calculating module may include an engine discharge HC amount calculating module and a total HC supply amount calculating module, and the diagnostic temperature parameter threshold setting module may include a reaction heat calculating module. The engine discharge HC amount calculating module calculates an HC amount discharged from the engine. The total HC supply amount calculating module calculates a total HC supply amount to be supplied to the exhaust emission control catalyst based on the HC amount discharged from the engine calculated by the engine discharge HC amount calculating module and the HC discharge amount calculated by the HC discharge amount calculating module. The reaction heat calculating module calculates a reaction heat rate produced in the exhaust emission control catalyst when the total HC supply amount is supplied to the exhaust emission control catalyst. The diagnostic temperature parameter threshold setting module may set the predetermined diagnostic temperature parameter threshold based on the reaction heat rate.

For the exhaust emission control catalyst including the HC adsorbing part, as described above, in addition to the oxidative reaction heat produced by HC discharged from the engine, the oxidative reaction heat produced by HC discharged from the HC adsorbing part is added. Thus, in the above configuration, by calculating the reaction heat when the total HC supply amount calculated based on the engine discharge HC amount and the HC discharge amount is supplied to the exhaust emission control catalyst, and setting the diagnostic temperature parameter threshold based on the reaction heat, in comparing the actual exhaust-emission-control-catalyst temperature parameter with the diagnostic temperature parameter threshold, since the influence of the oxidative reaction heat added by HC discharged from the HC adsorbing part is excluded, the false deterioration determination of the exhaust emission control catalyst due to the HC discharged from the HC adsorbing part can be prevented.

Further, the diagnostic temperature parameter threshold setting module may include an engine discharge CO amount calculating module for calculating an amount of CO discharged from the engine. The reaction heat calculating module may calculate the reaction heat rate produced in the exhaust emission control catalyst when the total HC supply amount and the calculated engine discharge CO amount are supplied to the exhaust emission control catalyst, and the diagnostic temperature parameter threshold setting module may set the diagnostic temperature parameter threshold based on the reaction heat rate.

The oxidative reaction heat in the exhaust emission control catalyst is distributed by CO discharged from the engine. Thus, in the above configuration, by calculating the reaction heat rate produced in the exhaust emission control catalyst when both the total HC supply amount and the calculated engine discharge CO amount are supplied to the exhaust emission control catalyst by the reaction heat calculating module, and setting the diagnostic temperature parameter threshold based on the reaction heat rate, the more accurate oxidative reaction heat can be calculated. Accordingly, the diagnostic temperature parameter threshold can be set more accurately and the false deterioration determination of the exhaust emission control catalyst due to the HC discharged from the HC adsorbing part can be prevented more surely.

Further, when the HC discharge amount is larger than a predetermined value, the false deterioration determination preventing module may restrict the deterioration determination performed by the deterioration determining module.

In the above configuration, by performing the diagnosis when the HC discharge amount is small, the diagnosis can be performed when the addition of the oxidative reaction heat in the exhaust emission control catalyst produced by HC discharged by the HC adsorbing part is small. Therefore, the false deterioration determination of the exhaust emission control catalyst due to the HC discharged from the HC adsorbing part can be prevented more surely.

According to another aspect of the invention, a method of determining deterioration of an exhaust emission control catalyst is provided. The exhaust emission control catalyst includes an HC adsorbing part and an oxidation catalyst part. The HC adsorbing part is disposed in an exhaust passage of an engine and adsorbs HC within exhaust gas when a temperature of the HC adsorbing part is lower than an HC dischargeable temperature and discharges the adsorbed HC when the temperature of the HC adsorbing part is higher than the HC dischargeable temperature. The oxidation catalyst part purifies, by oxidation, the HC discharged from the HC adsorbing part and the HC within the exhaust gas under a high temperature. The method includes detecting an actual exhaust-emission-control-catalyst temperature parameter correlating with an actual temperature of the exhaust emission control catalyst. The method also includes calculating an amount discharging HC from the HC adsorbing part. The method also includes setting a diagnostic temperature parameter threshold of the exhaust emission control catalyst based on the HC discharge amount. The method also includes determining that the exhaust emission control catalyst is deteriorated when the actual exhaust-emission-control-catalyst temperature parameter is lower than the diagnostic temperature parameter threshold by a predetermined value.

With the above configuration, since the deterioration is determined by calculating the HC discharge amount that varies depending on the engine operating state and the state of the HC adsorbing part, and comparing the diagnostic temperature parameter threshold of the exhaust emission control catalyst calculated based on the calculated HC discharge amount with the actual exhaust-emission-control-catalyst temperature parameter, the diagnosis is performed under consideration of oxidative reaction heat added by the HC discharged from the HC adsorbing part. Therefore, the false deterioration determination of the exhaust emission control catalyst due to the HC discharged from the HC adsorbing part can be prevented more surely.

### BRIEF DESCRIPTION OF THE DRAWINGS

FIG. 1 is a view of an overall configuration of an engine according to the present invention.

FIG. 2 is a view of a part of an exhaust emission control catalyst according to the present invention in an enlarged manner.

FIG. 3 is a block diagram of an overall configuration regarding an exhaust emission control catalyst diagnosis of a first embodiment of the present invention.

FIG. 4 is a flowchart (R1) of a main routine of a diagnostic control by an exhaust emission control catalyst deterioration diagnosing system of the first embodiment of the present invention.

FIG. 5 is a flowchart (R2) of a subroutine of calculating a supply reaction heat rate (ΔQdoc_in) per unit time in the first embodiment of the present invention.

FIG. 6 is a flowchart (R3) of a subroutine of detecting a reaction heat rate (ΔQdoc) per unit time in the first embodiment of the present invention.

FIG. 7 is a block diagram of a specific configuration for calculating an HC discharge amount (ΔHCdes) per unit time in the first embodiment of the present invention.

FIG. 8 is a flowchart (R4) of a subroutine of calculating a total HC adsorb amount (HCads) in the first embodiment of the present invention.

FIG. 9 is a block diagram of a specific configuration regarding an HC adsorbable ratio (Ea) calculating module of the first embodiment of the present invention.

FIG. 10 is a flowchart (R11) of a main routine of a diagnostic control with an exhaust emission control catalyst deterioration diagnosing method of a second embodiment of the present invention.

### DETAILED DESCRIPTION OF EMBODIMENTS

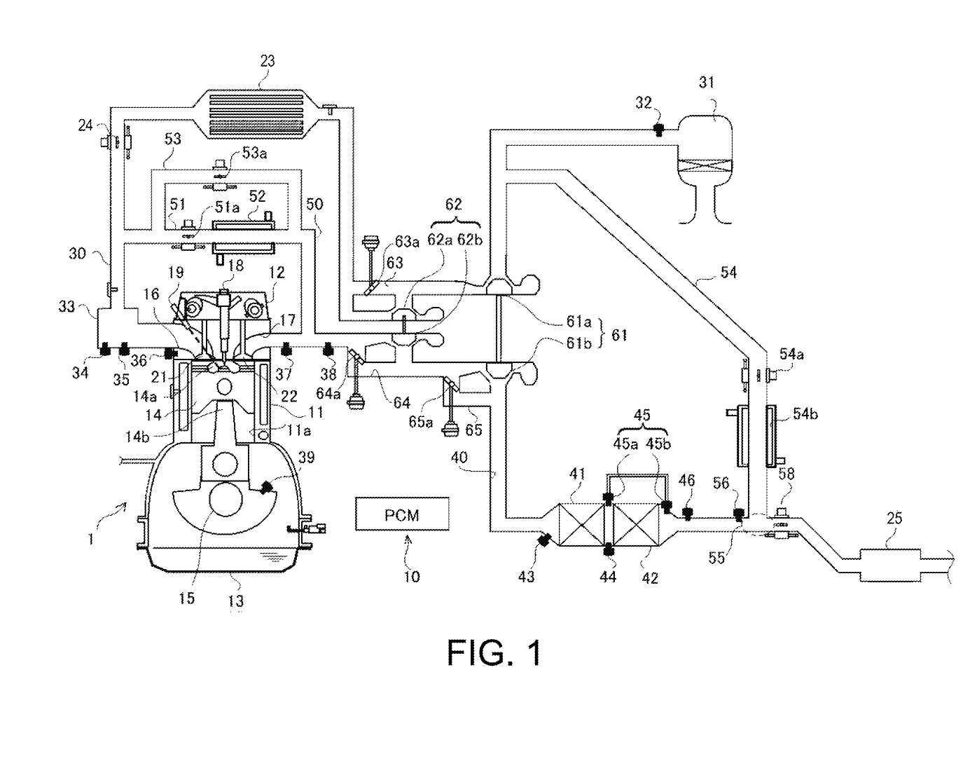

FIG. 1 is a view of an overall configuration of an engine 1 according to the present invention. The engine 1 is a diesel engine that is equipped in a vehicle and supplied with a fuel mainly containing a diesel fuel. The engine 1 includes a cylinder block 11 provided with a plurality of cylinders 11a (only one cylinder is illustrated in FIG. 1), a cylinder head 12 disposed on the cylinder block 11, and an oil pan 13 disposed below the cylinder block 11, where a lubricant is stored. Inside each of the cylinders 11a of the engine 1, a reciprocatable piston 14 is fitted, and a cavity forming a reentrant shape combustion chamber 14a is formed on a top face of the piston 14. The pistons 14 are coupled to a crankshaft 15 via connecting rods 14b, respectively.

In the cylinder head 12, each cylinder 11a is formed with an intake port 16 and an exhaust port 17, and provided with an intake valve 21 for opening and closing the intake port 16 on the combustion chamber 14a side and an exhaust valve 22 for opening and closing the exhaust port 17 on the combustion chamber 14a side.

In a valve train system of the engine 1 for operating the intake and exhaust valves 21 and 22, a hydraulically-actuated variable valve motion mechanism (hereinafter, referred to as the VVM) for switching an operation mode of the exhaust valve 22 between a normal mode and a special mode. In the normal mode, the exhaust valve 22 is opened only once during exhaust stroke in the normal mode, and in the special mode, the exhaust valve 22 operates a so-called exhaust open-twice control in which it opens once during exhaust stroke and once more during intake stroke.

In the cylinder head 12, an injector 18 for injecting the fuel and a glowplug 19 for heating intake air within the cylinder 11a in a cold start of the engine 1 to improve ignitability of the fuel are provided for each cylinder 11a. The injector 18 is arranged such that its fuel injection port is oriented toward the inside of the combustion chamber 14a from a ceiling face of the combustion chamber 14a, so that it directly supplies the fuel inside the combustion chamber 14a basically near a compression top dead center (CTDC).

To one side face of the engine 1, an intake passage 30 is connected to communicate with the intake ports 16 of the respective cylinders 11a. To the other side face of the engine 1, an exhaust passage 40 is connected to guide out burned gas (exhaust gas) discharged from the combustion chambers 14a of the cylinders 11a. A large turbocharger 61 and a small turbocharger 62 for turbocharging the intake air are disposed in the intake and exhaust passages 30 and 40.

An air cleaner 31 for filtrating intake air is disposed in an upstream end part of the intake passage 30. A surge tank 33 is disposed near a downstream end of the intake passage 30. A part of the intake passage 30 downstream of the surge tank 33 is branched to be independent passages extending toward the respective cylinders 11a, and downstream ends of the independent passages are connected to the intake ports 16 of the cylinders 11a, respectively.

Compressors 61a and 62a of the large and small turbochargers 61 and 62, an intercooler 23 for cooling air compressed by the compressors 61a and 62a, and a throttle valve 24 for adjusting an intake air amount for the combustion chambers 14a of the respective cylinders 11a are disposed in a part of the intake passage 30 between the air cleaner 31 and the surge tank 33. The throttle valve 36 is basically fully open, but it is fully closed when the engine is stopped so as to avoid a shock.

A part of the intake passage 30 between the surge tank 33 and the throttle valve 36 (i.e., a part downstream of the small compressor 62a of the small turbocharger 62) is connected to a part of the exhaust passage 40 between an exhaust manifold and a small turbine 62b of the small turbocharger 62 (i.e., a part upstream of the small turbine 62b of the small turbocharger 62) by an EGR passage 50 for recirculating a part of the exhaust gas back to the intake passage 30 (high-pressure EGR system). The EGR passage 50 includes a main passage 51 where an EGR cooler 52 and an exhaust gas recirculation valve 51a for adjusting a recirculation amount of the exhaust gas to the intake passage 30 are disposed, and a cooler bypass passage 53 bypassing the EGR cooler 52. A cooler bypass valve 53a for adjusting a flow rate of the exhaust gas flowing through the cooler bypass passage 53 is disposed within the cooler bypass passage 53.

Separately to the high-pressure EGR system, as a low-pressure EGR system, a part of the intake passage 30 upstream of the large compressor 61a of the large turbocharger 61 is connected to a part of the exhaust passage 40 downstream of a diesel particulate filter (DPF) 42 by an EGR passage 54 for recirculating a part of the exhaust gas back to the intake passage 30, via an EGR extracting section 55 formed in the exhaust passage 40. Moreover, the EGR passage 54 is provided with an EGR cooler 54b for cooling the exhaust gas and a low-pressure EGR valve 54a. Furthermore, an exhaust throttle valve 58 is disposed in a part of the exhaust passage 40 downstream of the EGR extracting section 55, and the exhaust throttle valve 58 adjusts the recirculation amount of the exhaust gas in the low-pressure EGR system to the intake passage 30 by controlling openings of the EGR valve 54a and the exhaust throttle valve 58 according to an operating state of the engine.

An upstream part of the exhaust passage 40 includes the exhaust manifold. The exhaust manifold has independent passages branched toward the respective cylinders 11a and connected to respective external ends of the exhaust ports 17, and a manifold section where the independent passages merge together.

A part of the exhaust passage 40 downstream of the exhaust manifold is provided with the turbine 62b of the small turbocharger 62, the turbine 61b of the large turbocharger 61, an exhaust emission control catalyst 41 for purifying HC and CO within the exhaust gas by oxidation, the DPF 42 for capturing diesel particulates, and a silencer 46, in this order from the upstream side. Note that the exhaust emission control catalyst 41 and the DPF 42 are accommodated in a single case.

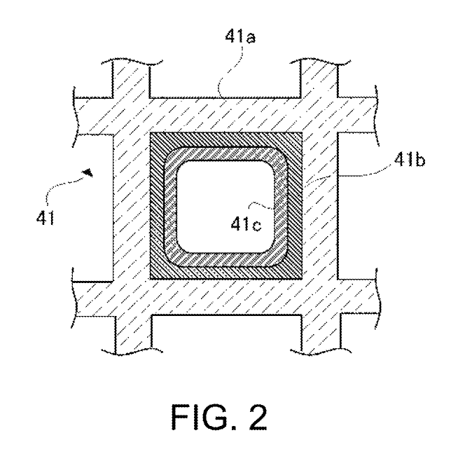

FIG. 2 illustrates a part of the exhaust emission control catalyst 41 in an enlarged manner. The exhaust emission control catalyst 41 includes a carrier 41a formed of a honeycomb structure made of cordierite, an oxidation catalyst part 41b supported by a wall surface of penetration holes formed in the carrier 41a, and an HC adsorbing part 41c. The HC adsorbing part 41c is a zeolite crystal formed with a plurality of fine pores that are approximately 0.5 mm in diameter. When the engine is at a low temperature (e.g., in the cold start), HC molecules within the exhaust gas are adsorbed by being trapped at the fine pores of zeolite, and when the engine is at a high temperature, the adsorbed HC molecules are discharged by vibrating and passing through the fine pores of zeolite. Moreover, the oxidation catalyst part 41b is made of a catalyst metal, such as platinum (Pt) and palladium (Pd), and has a function of purifying, by oxidation, HC and CO within the exhaust gas discharged from the engine as well as HC discharged from the HC adsorbing part 41c, by being heated to a predetermined temperature and activated. In other words, the exhaust emission control catalyst 41 has a function of temporarily adsorbing HC when the exhaust emission control catalyst is not activated (e.g., in the cold start) and HC cannot sufficiently be purified, and then to discharge and purify the adsorbed HC after the exhaust emission control catalyst is activated.

The diesel engine 1 with the configuration as described above is controlled by a powertrain control module (hereinafter, may be referred to as the PCM) 10 which controls the engine entirely. The PCM 10 is comprised of a microprocessor including a memory, a CPU, a counter timer group, an interface, and paths for connecting these units. The PCM 10 receives signals from, for example, an airflow sensor 32 for detecting an intake air amount at a position downstream of the air cleaner, an intake pressure sensor 34 attached to the surge tank 33 and for detecting a pressure of air to be supplied to the combustion chambers 14a, an intake air temperature sensor 35 attached to the surge tank 33 and for detecting a temperature of the intake air, a fluid temperature sensor 36 for detecting a temperature of an engine coolant, an exhaust gas pressure sensor 37 for detecting an exhaust gas pressure at a position downstream of the exhaust ports 17, an engine speed sensor 39 for detecting an engine speed by detecting a rotational angle of the crankshaft 15, an exhaust-emission-control-catalyst upstream exhaust gas temperature sensor 43 for detecting an exhaust gas temperature at a position upstream of the exhaust emission control catalyst 41, an exhaust-emission-control-catalyst downstream exhaust gas temperature sensor 44 for detecting an exhaust gas temperature at a position downstream of the exhaust emission control catalyst 41, a DPF pressure difference sensor 45 for detecting a pressure difference ΔP between upstream and downstream side of the DPF 42 (a pressure P₁ on the upstream side of the DPF—a pressure P₂ on the downstream side of the DPF), a linear O₂ sensor 46 for detecting an oxygen concentration within the exhaust gas, and an accelerator opening sensor (not illustrated) for detecting an accelerator opening corresponding to the an operation amount of an acceleration pedal of the vehicle. By performing various kinds of operations based on these signals, the PCM 10 determines the state of the engine 1 and further the vehicle, and outputs control signals to actuators including the injectors 18, the glowplugs 19, the VVM of the valve train (not illustrated), and various valves 36, 51a, 63a, 64a, and 65a. When the exhaust emission control catalyst 41 is determined by an exhaust emission control catalyst diagnosing system 120 (described later) as deteriorated, the PCM 10 outputs a signal to active an alarm device 130.

Further, the engine 1 is configured to have a comparatively low compression ratio, in which a geometric compression ratio is between 12:1 and 15:1 (e.g., 14:1), so as to improve exhaust emission performance and thermal efficiency.

### (Outline of Combustion Control of Engine)

A normal control of the engine 1 performed by the PCM 10 is for determining a target torque (i.e., a load to be targeted) based mainly on the accelerator opening, and achieving a fuel injection amount, a fuel injection timing, and the like corresponding to the target torque by controlling the operation of the injectors 18. The target torque is set to be higher as the accelerator opening becomes larger, and to reach its highest value when the engine speed is around 2,000 rpm. The fuel injection amount per predetermined crank rotation amount is set based on the target torque. The fuel injection amount is set larger as the target torque becomes higher, and the fuel is injected every time the crankshaft rotates by the predetermined rotation amount, here at predetermined timings between a late stage of the compression stroke and an early stage of expansion stroke which is every time the crankshaft fully rotates twice. Note that regarding the fuel injection control in this embodiment as, for example, the engine disclosed in JP2010-012972A, a plurality of operating ranges are set according to the engine load and the engine speed, and fuel injections at five timings including a pilot injection, a pre-injection, a main injection, an after injection, and a post injection are controlled, so as to reduce NOₓ and soot within the exhaust gas, reduce noises and vibrations, improve a fuel consumption, and increase the torque.

When a captured amount of PM by the DPF 42 exceeds a predetermined amount, a post injection into the combustion chamber of the engine 1 is performed by the injector 18 at a predetermined timing between exhaust stroke and a late stage of the expansion stroke (DPF regenerating processing) to prevent the increase of back pressure of the engine 1 due to the clogging of the DPF 42. After the post injection is performed, unburned fuel is discharged to the exhaust passage and the unburned fuel is oxidized by the exhaust emission control catalyst 41, and therefore, the oxidative reaction heat produced by the oxidation increases a temperature of the DPF 42, and thus the PM accumulated in the DPF 42 is burned, and as a result, the DPF 42 is regenerated.

In other words, the exhaust emission control catalyst 41 has, in addition to the above-described function of purifying, by the oxidation, the unburned fuel discharged from the engine, also the function of increasing the temperature of the DPF 42. When the deterioration of the exhaust emission control catalyst 41 progresses due to, for example, heat or poisoning by sulfur contained in the fuel and oil, since the functions described above cannot be exerted sufficiently, it becomes necessary to detect that the exhaust emission control catalyst 41 is deteriorated and to inform a person on board the deterioration of the exhaust emission control catalyst 41 to suggest an exchange. Therefore, the PCM 10 includes an exhaust emission control catalyst deterioration diagnosing system.

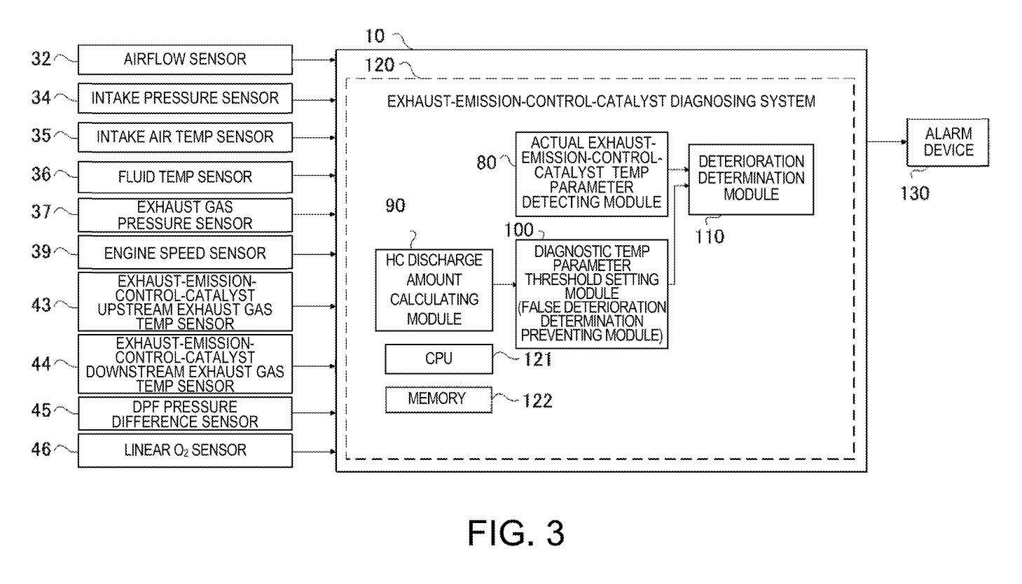

FIG. 3 is a block diagram of an overall configuration regarding the exhaust emission control catalyst diagnosis of the first embodiment of the present invention. The PCM 10 includes the exhaust emission control catalyst deterioration diagnosing system 120 for diagnosing the deterioration of the exhaust emission control catalyst 41. The exhaust emission control catalyst deterioration diagnosing system 120 receives signals from, for example, the airflow sensor 32, the intake pressure sensor 34, the intake air temperature sensor 35, the fluid temperature sensor 36, the exhaust gas pressure sensor 37, the engine speed sensor 39, the exhaust-emission-control-catalyst upstream exhaust gas temperature sensor 43, the exhaust-emission-control-catalyst downstream exhaust gas temperature sensor 44, the DPF pressure difference sensor 45, and the linear O₂ sensor 46, and a later-described deterioration diagnosis is performed by the exhaust emission control catalyst deterioration diagnosing system 120 by using these signals.

The exhaust emission control catalyst deterioration diagnosing system 120 includes an actual exhaust-emission-control-catalyst temperature parameter detecting module 80, an HC discharge amount calculating module 90 for calculating an HC amount discharged from the HC adsorbing part 41c, a diagnostic temperature parameter threshold setting module 100 for receiving a signal from the HC discharge amount calculating module 90 and setting a diagnostic temperature parameter threshold, a deterioration determining module 110 for determining the deterioration of the exhaust emission control catalyst by comparing a signal from the actual exhaust-emission-control-catalyst temperature parameter detecting module 80 with a signal from the diagnostic temperature parameter threshold setting module 100, a CPU 121 for performing various operations of the exhaust emission control catalyst deterioration diagnosing system, and a memory 122 for storing parameters calculated by the operations.

Although the details are described later, by comparing a diagnostic temperature parameter threshold (in the first embodiment, corresponding to a supply reaction heat rate Qdoc_in in a predetermined period of time, which is estimated to be produced by the exhaust emission control catalyst in a non-deteriorated state) with an actual exhaust-emission-control-catalyst temperature parameter (in the first embodiment, corresponding to an actual reaction heat rate Qdoc in a predetermined period of time, which is detected based on the signal from the exhaust-emission-control-catalyst downstream exhaust gas temperature sensor 44, etc.) to determine the deterioration of the exhaust emission control catalyst, the influence of the oxidative reaction heat added by HC discharged from the HC adsorbing part is excluded and the false deterioration determination of the exhaust emission control catalyst 41 due to the HC discharged from the HC adsorbing part is prevented. In other words, in the first embodiment, the diagnostic temperature parameter threshold setting module 100 for setting the diagnostic temperature parameter threshold based on the HC discharge amount serves as a false deterioration determination preventing module for preventing the deterioration determining module from performing false determinations because of the increase of the actual exhaust-emission-control-catalyst temperature parameter due to the increase of the HC discharge amount.

When the exhaust emission control catalyst is determined as deteriorated by the exhaust emission control catalyst deterioration diagnosing system 120, the PCM 10 outputs the signal to activate the alarm device 130.

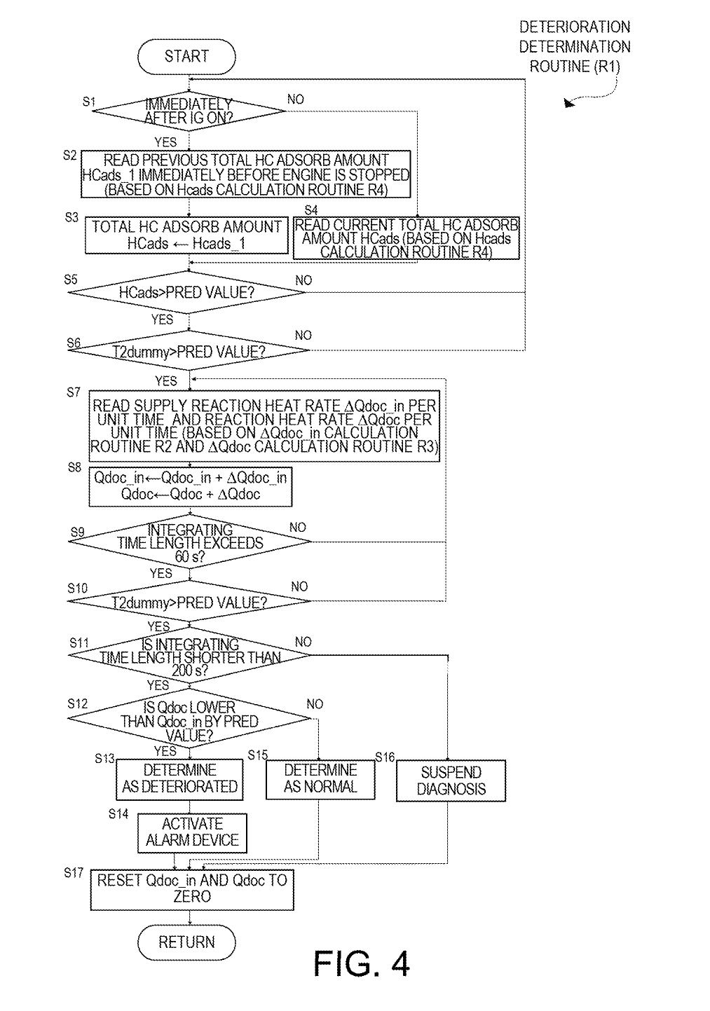

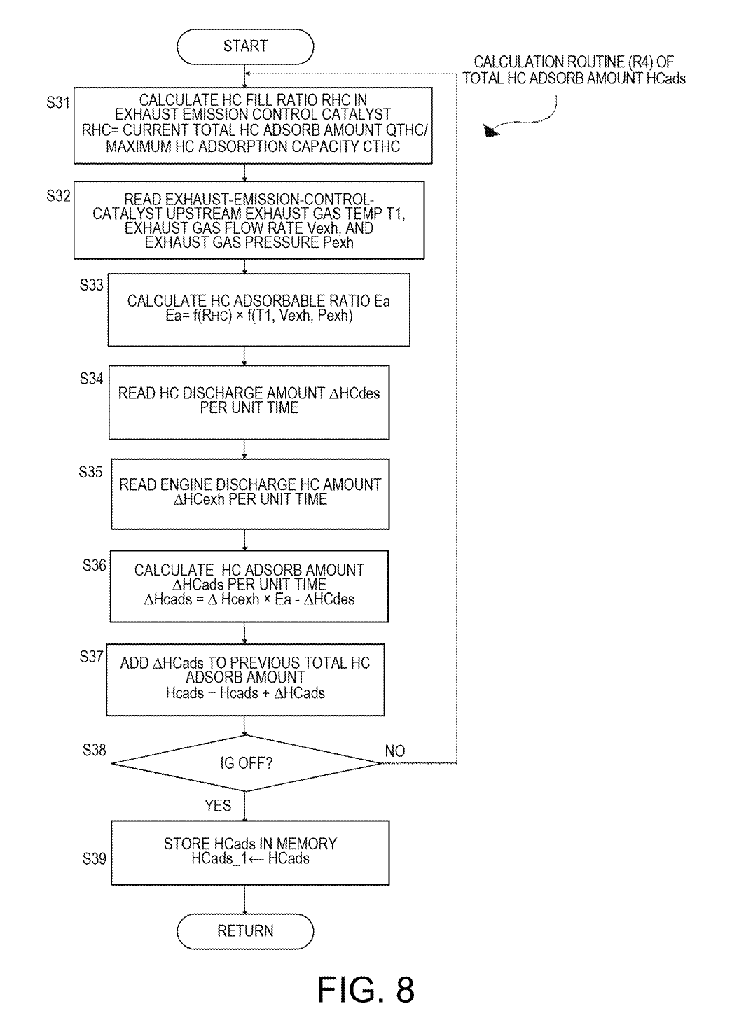

FIG. 4 is a flowchart (R1) of a main routine of the diagnostic control of the exhaust emission control catalyst deterioration diagnosing system of the first embodiment. First, when the ignition (IG) is turned on, at S1, whether a current timing is immediately after the IG is turned on is determined, and if it is immediately after the IG is turned on, a previous total HC adsorb amount HCads_{—}1 immediately before the engine is stopped which is stored in the memory 122, is read (S2), and HCads_{—}1 is set as a current total HC adsorb amount HCads (S3). Although the details are described with the flowchart of a subroutine of calculating the total HC adsorb amount in FIG. 8, if the IG is turned off while a temperature of the HC adsorbing part is lower than a predetermined temperature, since a predetermined amount of HC still remains adsorbed by the HC adsorbing part, this situation needs to be considered in calculating the total HC adsorb amount. Thus, a total HC adsorb amount HCcads_{—}1 immediately before the IG is turned off is stored in the memory 122, and when the engine is started next time, HCcads_{—}1 is set as an initial value of the total HC adsorb amount HCads. On the other hand, if it is determined that the current timing is not immediately after the IG is turned on at S1, the current total HC adsorb amount HCads is read. The current total HC adsorb amount HCads is calculated sequentially as described with the flowchart of the subroutine of calculating the total HC adsorb amount in FIG. 8, and a latest value of the calculation result is stored in the memory 122, and therefore, the stored HCads can be read to obtain the current total HC adsorb amount HCads. Sequentially, at S5 and S6, whether predetermined diagnosis executing conditions of the deterioration determination of the exhaust emission control catalyst are met is determined.

At S5, whether HCads is larger than a predetermined value (e.g., 0.5 g or larger) is determined, and if it is larger than the predetermined value, the diagnostic condition is considered as met and the control proceeds to S6; whereas if it is not higher than the predetermined value, the diagnostic condition is considered as not met and the control returns to S1. As described above, with the exhaust emission control catalyst including the HC adsorbing part, it becomes necessary to prevent the false deterioration determination of the exhaust emission control catalyst due to the oxidative reaction heat added by the HC discharged from the HC adsorbing part. Thus, in the first embodiment, as described later, by determining the deterioration through comparing the diagnostic temperature parameter threshold Qdoc_in which varies based on the HC discharge amount, with the actual reaction heat rate Qdoc, the false deterioration determination caused by the HC discharged from the HC adsorbing part is prevented. When using this method, as described later, regardless of how large the HC discharge amount is, the false deterioration determination caused by the HC discharged from the HC adsorbing part can be prevented. On the other hand, when diagnosing the deterioration of the exhaust emission control catalyst based on the strength of the oxidative reaction heat in the exhaust emission control catalyst, it is preferred to diagnose when the oxidative reaction heat is stronger to improve the diagnostic accuracy. Thus, in the first embodiment, considering that the false deterioration determination due to the HC discharged from the HC adsorbing part can be prevented regardless of the HC discharge amount and that the oxidative reaction heat becomes stronger by the amount of unburned fuel supplied to the oxidation catalyst part increasing when the HC discharge amount is large, the diagnosis is started (integration of reaction heat rates Qdoc and integration of supply reaction heat rates Qdoc_in are started) when the total HC adsorb amount HCads is larger than the predetermined value and the HC discharge amount is estimated to be large (S5). In other words, in the first embodiment, by diagnosing when the amount of unburned fuel supplied to the oxidation catalyst part is large while preventing the false deterioration determination due to the HC discharged from the HC adsorbing part, the deterioration diagnostic accuracy of the exhaust emission control catalyst improves more.

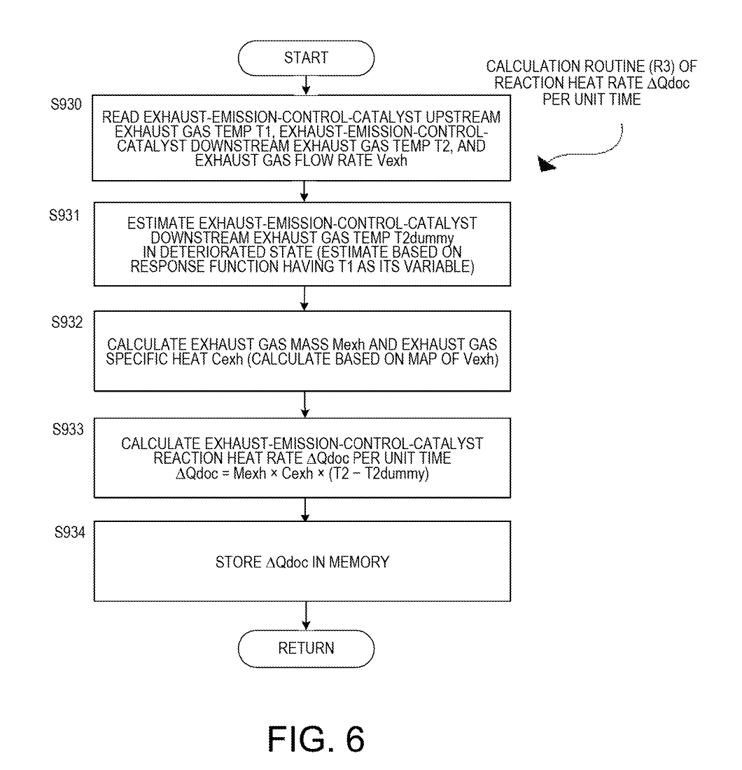

Next, at S6, whether an exhaust-emission-control-catalyst downstream exhaust gas estimated temperature T2dummy in a catalyst which is a deteriorated exhaust emission control catalyst and where the oxidative reaction does not occur (hereinafter, may be referred to as the dummy catalyst) is higher than a predetermined value (e.g., 160° C. or higher), and if T2dummy is higher than the predetermined value, the diagnostic condition is considered as met and the control proceeds to S7. On the other hand, if T2dummy is lower than the predetermined value, the diagnostic condition is considered as not met and the control returns to S1. Note that the T2dummy calculation method is described in detail in a later-described subroutine in FIG. 6 of detecting a reaction heat rate ΔQdoc per unit time. For the deterioration diagnosis of the exhaust emission control catalyst by using the oxidative reaction heat, an exhaust emission control catalyst temperature range suitable for the diagnosis exists. In other words, when an exhaust emission control catalyst temperature is low (e.g., lower than 160° C.), due to the activation of the exhaust emission control catalyst not being sufficient in addition to the HC adsorb amount by the HC adsorbing part being large and the amount of unburned fuel supplied to the oxidation catalyst part being small, the detected oxidative reaction heat becomes weak and the diagnostic accuracy degrades. On the other hand, the exhaust emission control catalyst temperature is high (e.g., 200° C. or higher), the oxidative reaction in the oxidation catalyst part easily occurs and, therefore, it is not suitable for the diagnosis for detecting a small level of deterioration. Thus, in the first embodiment, the diagnosis is performed based on the exhaust emission control catalyst temperature parameter and the diagnostic temperature parameter threshold when the exhaust emission control catalyst temperature is within a predetermined temperature range (160° C. or high but lower than 200° C.). Note that T2dummy, as described later, is the exhaust gas temperature at the position downstream of the exhaust emission control catalyst where the oxidative reaction does not occur, and since the amount of temperature increase by the oxidative reaction heat is subtracted therefrom, whether the exhaust emission control catalyst is within the predetermined temperature range can be determined more accurately.

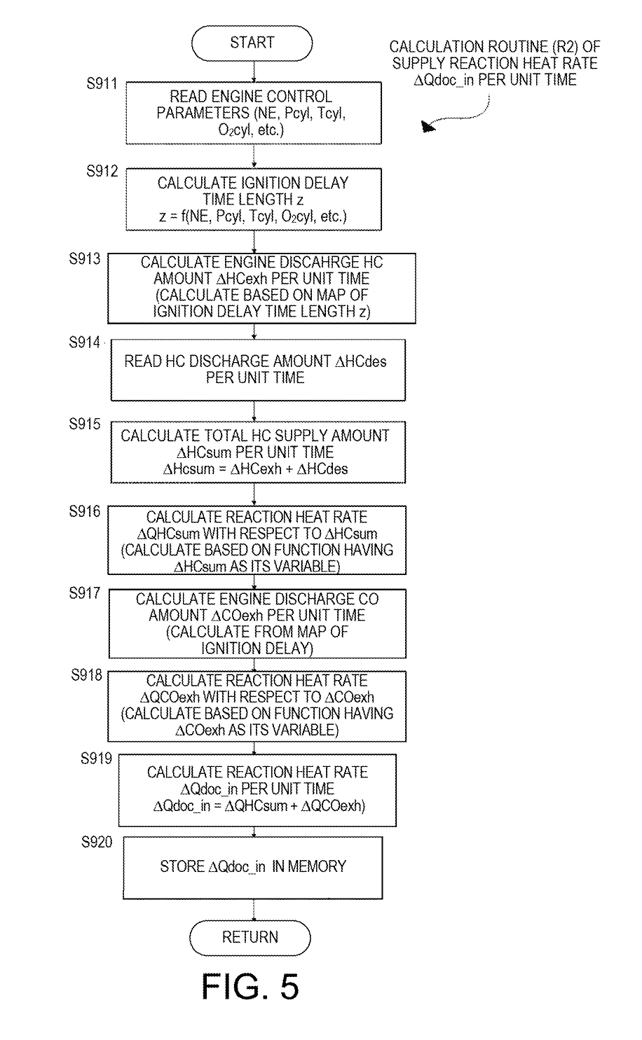

Next, at S7, a value of the supply reaction heat rate ΔQdoc_in estimated to be produced per unit time in the non-deteriorated exhaust emission control catalyst (the supply reaction heat rate per unit time which is sequentially calculated in the routine (R2) in FIG. 5 described later) and a value of a reaction heat rate ΔQdoc actually produced per unit time in the exhaust emission control catalyst (the reaction heat rate per unit time which is sequentially calculated in the routine (R3) in FIG. 6 described later) are read. Then ΔQdoc_in is added to Qdoc_in which is a previous integrated value of the supply reaction heat rates, and the result thereof serves as a latest supply reaction heat rate integrated value Qdoc_in. ΔQdoc is added to Qdoc which is a previous integrated value of the reaction heat rates, and the result thereof serves as a latest reaction heat rate integrated value Qdoc. These addition calculations are repeated until an integrating period of time exceeds 60 s (S7 to S9). Note that each of initial values of Qdoc and Qdoc_in is set to zero in advance before the diagnosis is started (since, as described later at S18, the values of Qdoc and Qdoc_in are reset to zero when the diagnosis completes). Instantaneous values, such as ΔQdoc and ΔQdoc_in, vary easily due to, for example, the change of the operating state of the engine, and therefore, in this embodiment, the diagnosis is performed by using Qdoc and Qdoc_in which are the integrated values of ΔQdoc and ΔQdoc_in in the predetermined time period. Note that as described above, in this first embodiment, Qdoc corresponds to the actual exhaust-emission-control-catalyst temperature parameter and Qdoc_in corresponds to the diagnostic temperature parameter threshold. Sequentially, the ΔQdoc calculation method and the ΔQdoc_in calculation method are described with reference to FIGS. 5 and 6, respectively.

FIG. 5 is a flowchart of a subroutine of calculating the supply reaction heat rate ΔQdoc_in per unit time. First, at S911, an engine speed NE detected by the engine speed sensor 39, an in-cylinder pressure Pcyl at a piston top dead center (the pressure at the end of compression stroke) calculated based on the various sensor signals, an in-cylinder temperature Tcyl at the piston top dead center, and an in-cylinder O₂ concentration O₂cyl are read. Although the method of calculating the in-cylinder pressure Pcyl and the in-cylinder temperature Tcyl is not particularly limited, since the in-cylinder pressure Pcyl and the in-cylinder temperature Tcyl correlate with parameters regarding the engine operation, such as the geometric compression ratio, the intake air temperature, an atmospheric pressure (or an intake air pressure), the engine fluid temperature, an effective compression ratio, the engine load, the fuel injection amount, and a fuel injection pressure, these parameters are detected or estimated by using the various sensors, and each of the in-cylinder pressure Pcyl and the in-cylinder temperature Tcyl may be calculated by using either one of a function and a map determined by, for example, a test on the detected value or the estimated value in advance. Specifically, the in-cylinder pressure Pcyl and the in-cylinder temperature Tcyl are calculated to be higher as any one of the intake air temperature, the engine fluid temperature, the effective compression ratio, and the engine load is higher.

Moreover, although the in-cylinder O₂ concentration calculation method is also not limited, for example, a fresh air amount passing through the air cleaner 31 is detected by the airflow sensor 32, and an intake O₂ concentration is calculated based on an O₂ concentration of fresh air stored in the memory 122 in advance, the fresh air amount, the exhaust O₂ concentration detected by the linear O₂ sensor 46, an EGR gas amount calculated by a pressure sensor at a position upstream/downstream of the EGR passage, or the like. A fill amount of intake air is calculated based on, for example, a volume efficiency set according to the engine operating state stored in the memory 122 in advance, an in-cylinder remaining exhaust gas amount is calculated based on, for example, the exhaust gas pressure sensor 37, and an in-cylinder remaining exhaust gas O₂ concentration is estimated by the linear O₂ sensor 46. Then, the in-cylinder O₂ concentration O₂cyl may be calculated based on the fill amount, the in-cylinder remaining exhaust gas amount, the intake O₂ concentration, and the in-cylinder remaining exhaust gas O₂ concentration.

Next, at S912, an ignition delay time length z is calculated. Here, the ignition delay time length z indicates a delay in time from the fuel is injected until the fuel ignites, for example, in pre-mixture combustion, a time length from the end of a plurality of fuel injections performed at a predetermined time interval on the compression stroke until the fuel combusts by self-ignition near a top dead center (TDC), and in diffusion combustion, a time length from a start of the main injection until the combustion starts. The ignition delay time length z can be calculated based on, for example, the in-cylinder pressure Pcyl, the in-cylinder temperature Tcyl, the engine speed NE (the detection value of the engine speed sensor 39), and the in-cylinder O₂ concentration O₂cyl. In other words, the ignition delay time length becomes shorter as the in-cylinder pressure Pcyl is higher and the in-cylinder temperature Tcyl is higher since self-ignition occurs more easily, the ignition delay time length becomes longer as the engine speed is higher since a period of time in which a temperature of mixture gas is high becomes shorter, and the ignition delay time length becomes longer as the in-cylinder O₂ concentration O₂cyl is lower (the EGR ratio is higher) since the combustion becomes harder to perform. Specifically, the ignition delay time length z can be calculated based on the following relation equation of the ignition delay time length z: z=A×Pcyl^{B}×exp(1/Tcyl)^{C}×NE^{D}×O₂cyl^{E}. The A, B, C, and D are constants and may be obtained by, for example, a test in advance.

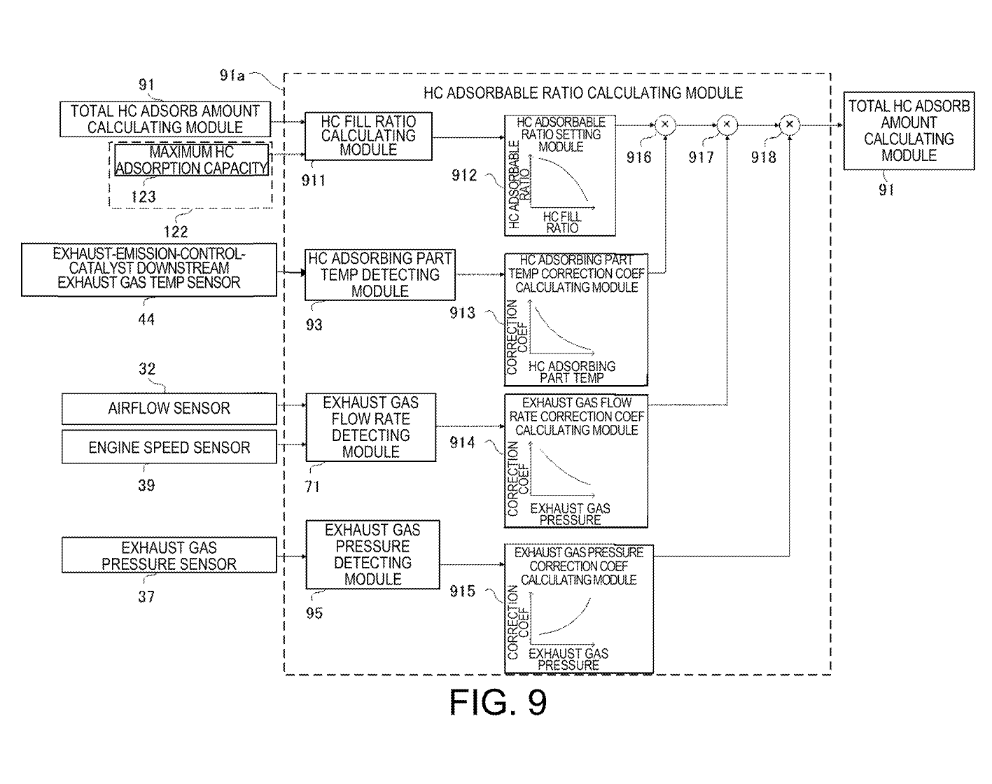

Next, at S913, an engine discharge HC amount ΔHCexh per unit time is calculated based on the ignition delay time length z. Specifically, when the ignition delay time length z is long and the ignition occurs at a timing later than a desired combustion timing on the expansion stroke, the fuel combustion becomes incomplete combustion, and the amount of HC discharged from the engine becomes larger. Therefore, ΔHCexh is calculated based on either one of a map and a function determined by, for example, a test or theoretical values in advance, so that ΔHCexh becomes larger as the ignition delay time length z becomes longer. Sequentially, at S914, an HC discharge amount ΔHCdes from the HC adsorbing part per unit time detected by the HC discharge amount calculating module 90 is read. Note that the HC discharge amount ΔHCdes calculation method is described later with reference to FIG. 9. Sequentially, at S915, the engine discharge HC amount ΔHCexh is added to the HC discharge amount ΔHCdes to calculate a total HC supply amount ΔHCsum to the exhaust emission control catalyst 41 per unit time. Next, at S916, a reaction heat rate ΔQHCsum is calculated by a reaction heat calculating module of the diagnostic temperature parameter threshold setting module 100. The reaction heat rate ΔQHCsum is estimated to be produced when the total HC supply amount ΔHCsum is supplied to the exhaust emission control catalyst 41 in the non-deteriorated state. ΔQHCsum may be calculated based on either one of a map of the total HC supply amount (ΔHCsum) and the reaction heat rate obtained by a test or theoretical values in advance, and a function having the HC amount (ΔHCsum) as its variable.

Next, at S917, an engine discharge CO amount ΔCOexh per unit time is calculated based on the ignition delay time length z. Specifically, when the ignition delay time length z is long and the ignition occurs at a timing later than a desired combustion timing on the expansion stroke, the fuel combustion becomes incomplete combustion, and the amount of CO discharged from the engine becomes larger. Therefore, ΔCOexh is calculated based on either one of a map and a function determined by, for example, a test or theoretical values in advance, so that ΔCOexh becomes larger as the ignition delay time length z becomes longer. Sequentially, at S918, a reaction heat rate ΔQCOexh estimated to be produced when ΔCOexh is supplied to the exhaust emission control catalyst in the non-deteriorated state is calculated. ΔQCOexh may be calculated based on either one of a map of the CO amount (ΔCOsum) and the reaction heat rate obtained by a test or theoretical values in advance, and a function having the CO amount (ΔCOsum) as its variable. Then, at S919, the calculated ΔQHCsum and ΔQCOexh are added to calculate the supply reaction heat rate ΔQdoc_in per unit time, and at S920, the supply reaction heat rate ΔQdoc_in is stored as a latest value of the supply reaction heat rate ΔQdoc_in in the memory 122 so as to be read at S7 in FIG. 4.

By calculating the total HC supply amount ΔHCsum supplied to the exhaust emission control catalyst is calculated while taking the HC discharge amount into consideration, and by calculating the supply reaction heat rate ΔQdoc_in per unit time based on the total HC supply amount ΔHCsum as described above, the supply reaction heat rate ΔQdoc_in per unit time estimated to be produced in the exhaust emission control catalyst in the non-deteriorated state can be calculated more accurately, and the supply reaction heat rate Qdoc_in which is the integrated value of ΔQdoc_in in the predetermined time period can be calculated more accurately. Moreover, since the oxidative reaction heat rate produced according to the engine discharge CO amount is taken into consideration in calculating ΔQdoc_in, ΔQdoc_in and Qdoc_in can be calculated more accurately.

Next, the detection method of the reaction heat rate ΔQdoc per unit time (the reaction heat rate actually produced in the exhaust emission control catalyst) is described with reference to FIG. 6.

FIG. 6 is the flowchart of the subroutine of detecting the reaction heat rate ΔQdoc per unit time. First, at S930, an exhaust-emission-control-catalyst upstream exhaust gas temperature T1 detected by the exhaust-emission-control-catalyst upstream exhaust gas temperature sensor 43, an exhaust-emission-control-catalyst downstream exhaust gas temperature T2 detected by the exhaust-emission-control-catalyst downstream exhaust gas temperature sensor 44, an exhaust gas flow rate Vexh detected by an exhaust gas flow rate detecting module 71 (described later) that is used with the HC discharge amount calculating module 90 are read. Note that a detection value from the exhaust gas flow rate detecting module 71 provided to an HC adsorbable ratio calculating module 91a (described later) may be read as the exhaust gas flow rate Vexh.

Next, at S931, the exhaust-emission-control-catalyst downstream exhaust gas estimated temperature T2dummy in the state where the oxidative reaction by the exhaust emission control catalyst does not occur, in other words, which does not include a catalyst oxidative reaction temperature, is estimated. Although the estimation method of the exhaust-emission-control-catalyst downstream exhaust gas estimated temperature T2dummy is not particularly limited, in the first embodiment, it is estimated based on a response function having T1 as its variable, T1 being set based on properties obtained by a test in advance with a vehicle installed therein with the dummy catalyst which is a deteriorated exhaust emission control catalyst and where the oxidation reaction does not occur (e.g., an exhaust pipe, a thermal capacity of the exhaust emission control catalyst, and a thermal transfer ratio). Here, a blank time length for the exhaust gas to flow from a position where the exhaust-emission-control-catalyst upstream exhaust gas temperature detecting sensor 43 for detecting T1 is disposed, to a position where the exhaust-emission-control-catalyst downstream exhaust gas temperature detecting sensor 44 for detecting T2 is disposed is preferred to be considered. By considering such a blank time length, when calculating a difference between T2dummy and T2 so as to calculate the reaction heat rate Qdoc produced in the exhaust emission control catalyst at S933 described later, the moved amount of exhaust gas can be matched between the cases of detecting T2dummy and T2, and therefore, the reaction heat rate Qdoc can be calculated more accurately.

Next, at S932, an exhaust gas mass Mexh and an exhaust gas specific heat Cexh are estimated based on the exhaust gas flow rate Vexh, and at S933, Mexh, Cexh, and the difference between T2 and T2dummy (T2-T2dummy) are calculated, and thus, the reaction heat rate ΔQdoc per unit time is calculated. At 5934, the reaction heat rate ΔQdoc per unit time is updated and stored in a predetermined memory so that the latest reaction heat rate ΔQdoc per unit time is read at S7 in FIG. 4.

By calculating the oxidative reaction heat rate in the exhaust emission control catalyst based on the difference between T2dummy and T2 as described above, the influence on the temperature increase by factors other than the oxidative reaction can be excluded, and therefore, the oxidative reaction heat rate only can be calculated more accurately. In other words, the influence of temperature changing factors other than the oxidative reaction heat in the exhaust emission control catalyst, for example, the state of the exhaust gas and the heat being transferred to an exhaust emission control catalyst case is included in T2 which is the detection value from the exhaust-emission-control-catalyst downstream exhaust gas temperature sensor 44. Thus, in this embodiment, firstly, the exhaust-emission-control-catalyst downstream exhaust gas temperature T2dummy which only includes the temperature changing factors other than the oxidative reaction heat, in other words, which only exclude the temperature change of the oxidative reaction heat, is estimated, the reaction heat rate ΔQdoc per unit time is calculated by using the temperature T2-T2dummy obtained by subtracting T2dummy from T2 as the exhaust-emission-control-catalyst downstream exhaust gas temperature, and the temperature changing factors other than the oxidative reaction heat are excluded.

Next, at S7 in the main routine of FIG. 4, the latest ΔQdoc_in which is calculated and stored in the subroutine of FIG. 5, is added to previously calculated Qdoc_in, and Qdoc_in and Qdoc are updated. Then, this update is repeated until the integrating time length exceeds 60 s (S7 to S9). In other words, since ΔQdoc_in and ΔQdoc vary due to, for example, the engine operating state, the deterioration diagnostic accuracy is improved by performing the integration in calculating Qdoc and Qdoc_in for at least over 60 s.

When the integrating time length exceeds 60 s, the control proceeds to S10, where whether T2dummy is higher than the predetermined value is determined. In other words, when T2dummy is higher than the predetermined value (e.g., 200° C.), the exhaust emission control catalyst is activated, and if the exhaust emission control catalyst is not deteriorated, Qdoc including sufficient oxidative reaction heat can be obtained, and thus, Qdoc suitable for the diagnosis is considered as obtained and the control proceeds to S11. On the other hand, if T2dummy is lower than the predetermined value, the suitable Qdoc is considered as not obtained and the integrations of Qdoc and Qdoc_in at S7 and S8 are repeated until T2dummy becomes higher than the predetermined value. By repeating the integration of Qdoc until the sufficient Qdoc is obtained, the deterioration diagnostic accuracy is improved.

Sequentially, at S11, whether the integrating time length is shorter than 200 s is determined, and if it is shorter than 200 s, the control proceeds to S12; whereas if it is longer than 200 s, the timing is considered as not suitable for the diagnosis and the control proceeds to S16 where the diagnosis is suspended. In other words, when the integrating time length of Qdoc and Qdoc_in exceeds 200 s, there is a possibility that a total detection error of the exhaust-emission-control-catalyst upstream exhaust gas temperature sensor 43 and the exhaust-emission-control-catalyst downstream exhaust gas temperature sensor 44 which are used to calculate Qdoc and Qdoc_in respectively, is large and thus, the deterioration diagnostic accuracy may degrade. Therefore, the diagnosis is suspended when the diagnosing time (integrating time length) exceeds 200 s (S16), to end the diagnosis.

Next, at S12, whether Qdoc is lower than Qdoc_in by a predetermined value is determined, and if it is lower by the predetermined value, the oxidative reaction in the exhaust emission control catalyst is considered as excessively low and the deterioration of the exhaust emission control catalyst is determined (S13), and the alarm device is activated (S14). On the other hand, if Qdoc is not lower by the predetermined value, the oxidative reaction in the exhaust emission control catalyst is considered as sufficient and the exhaust emission control catalyst is determined as normal, in other words, not deteriorated (S15). Note that although the deterioration determination method based on the comparison between Qdoc and Qdoc_in described above is not particularly limited, the exhaust emission control catalyst may be determined as deteriorated, for example, when the difference between Qdoc and Qdoc_in is larger than a predetermined value or when a heat release ratio which is a ratio between Qdoc and Qdoc_in (=Qdoc/Qdoc_in) is lower than a predetermined value.

By performing the deterioration determination through comparing the supply reaction heat rate Qdoc_in (diagnostic temperature parameter threshold) including the HC discharged from the HC adsorbing part 41c and estimated to be produced in the exhaust emission control catalyst in the non-deteriorated state, with the reaction heat rate Qdoc (actual exhaust-emission-control-catalyst temperature parameter) actually produced in the exhaust emission control catalyst as described above, the influence of the HC discharged from the HC adsorbing part is excluded, and therefore, the false deterioration determination of the exhaust emission control catalyst due to the addition of the oxidative reaction heat produced by the HC discharged from the HC adsorbing part can be prevented. Specifically, the exhaust gas temperature detected by the temperature sensor 44 downstream of the exhaust emission control catalyst is a temperature influenced by the oxidative reaction heat which is produced by the HC discharged from the HC adsorbing part, and the detected Qdoc which is the actual exhaust-emission-control-catalyst temperature parameter detected based on this exhaust gas temperature, includes the reaction heat rate influenced by the oxidative reaction heat produced by the HC discharged from the HC adsorbing part. On the other hand, by using, as the diagnostic temperature parameter threshold, the supply reaction heat rate Qdoc_in estimated to be produced in the exhaust emission control catalyst based on the calculation taking the HC discharge amount into consideration, and determining the deterioration through comparing Qdoc_in with Qdoc, both of Qdoc_in and Qdoc serve as parameters including the HC discharged from the HC adsorbing part, and therefore, the diagnosis taking the addition of the oxidative reaction heat produced by the HC discharged from the HC adsorbing part into consideration can be performed. Moreover, with the method of the first embodiment, regardless of the HC discharge amount, the false deterioration determination due to the HC discharged from the HC adsorbing part can be prevented, and therefore, limitation in the diagnosis executing conditions, for example, the diagnosis is limited when the HC discharge amount is large, is not required and the diagnostic frequency can be secured.

Note that in the first embodiment, the supply reaction heat rate Qdoc_in when the exhaust emission control catalyst is in the non-deteriorated state is used as the diagnostic temperature parameter threshold; however, the supply reaction heat rate Qdoc_in when the exhaust emission control catalyst is deteriorated to a predetermined level may be used. In this case, either one of a function and a map used for calculating the reaction heat rate ΔHCsum with respect to the total HC supply amount at S916 in the subroutine of FIG. 5 and the engine discharge CO amount ΔCOexh at S918 may be set based on the relationship between ΔHCsum and the reaction heat rate and the relationship between ΔCOexh and the reaction heat rate. Here, the deterioration determination may be performed when the difference between Qdoc and Qdoc_in is smaller than the predetermined value. Moreover, in the first embodiment, Qdoc which is the integrated value of ΔQdoc is used as the actual exhaust-emission-control-catalyst temperature parameter and Qdoc_in which is the integrated value of ΔQdoc_in is used as the diagnostic temperature parameter threshold; however, to simplify the control, ΔQdoc may be used as the actual exhaust-emission-control-catalyst temperature parameter and ΔQdoc_in may be used as the diagnostic temperature parameter threshold, and alternatively, to further simplify the control, the detection value T2 from the exhaust emission control catalyst downstream exhaust gas temperature sensor 44 may be the actual exhaust-emission-control-catalyst temperature parameter and the exhaust-emission-control-catalyst downstream exhaust gas temperature estimated value calculated based on the HC discharge amount may be the diagnostic temperature parameter.

Moreover, in this first embodiment, in calculating the supply reaction heat rate Qdoc_in which is the diagnostic temperature parameter threshold, the HC discharge amount ΔHCdes per unit time is read sequentially (S914), and the reaction heat rate ΔQHCsum per unit time containing ΔHCdes is calculated sequentially (S916); however, it may be such that a fixed value of the diagnostic temperature parameter threshold is stored in the memory 122 in advance, the HC discharge amount ΔHCdes per unit time are integrated, a correction coefficient may be calculated by using either one of a map and a function of the correction coefficient for the HC discharge amount integrated value obtained by a test or the like in advance, and then a diagnostic temperature parameter threshold which is the fixed value corrected based on the correction coefficient is compared to the actual exhaust-emission-control-catalyst temperature parameter to determine the deterioration of the exhaust emission control catalyst.

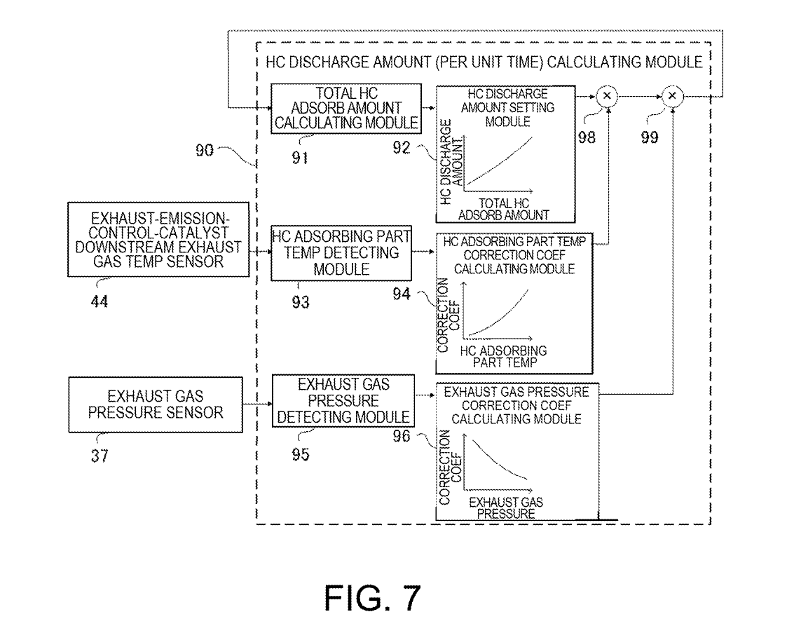

On the other hand, when preventing, with the method described above, the false determination of the deterioration determining module which is caused by the increase of the actual exhaust-emission-control-catalyst temperature parameter due to the HC discharged from the HC adsorbing part, it becomes important to calculate the HC discharge amount per unit time accurately. Thus, in the first embodiment, the HC discharge amount per unit time is calculated with the following method. FIG. 7 is a block diagram of a specific configuration regarding the HC discharge amount calculating module 90. The HC discharge amount calculating module 90 includes a total HC adsorb amount calculating module 91, an HC discharge amount setting module 92 for receiving a signal from the total HC adsorb amount calculating module 91 and setting the HC discharge amount, an HC adsorbing part temperature detecting module 93 for receiving the signal from the exhaust-emission-control-catalyst downstream exhaust gas temperature sensor 44 and calculating the temperature of the HC adsorbing part, an HC adsorbing part temperature correction coefficient calculating module 94 for receiving a signal from the HC adsorbing part temperature detecting module 93 and calculating an adsorbing part temperature correction coefficient, an exhaust gas pressure detecting module 95 for receiving the signal from the exhaust gas pressure sensor 37 and calculating an exhaust gas pressure at the entrance of the exhaust emission control catalyst 41, an exhaust gas pressure correction coefficient calculating module 96 for receiving a signal from the exhaust gas pressure detecting module 95 and calculating the exhaust gas pressure correction coefficient, a multiplying module 98 for multiplying the HC discharge amount set by the HC discharge amount setting module 92 by the correction coefficient calculated by the HC adsorbing part temperature correction coefficient calculating module 94, and a multiplying module 99 for multiplying the calculated value from the multiplying module 98 by the correction coefficient calculated by the exhaust gas pressure correction coefficient calculating module 96.

The HC discharge amount per unit time increases as the total HC adsorb amount becomes larger. Moreover, the HC discharge amount per unit time correlates with the HC adsorbing part temperature, and the HC discharge amount per unit time increases as the HC adsorbing part temperature becomes higher since a desorbing speed of the adsorbed HC becomes higher. Moreover, the HC discharge amount per unit time correlates with the exhaust gas pressure, and the HC discharge amount per unit time becomes larger as the exhaust gas pressure becomes lower. In other words, since the adsorption of HC is achieved by the crystal part (e.g., zeolite) being chemically coupled to HC and the HC is discharged when it is uncoupled and the temperature reaches to a level where it can be desorbed (boiling point), when the exhaust gas pressure is high and the pressure at the HC adsorbing part is high, the boiling point at which HC can be desorbed rises and it becomes difficult to discharge HC. Thus, the HC discharge amount per unit time becomes smaller. Therefore, a base value of the HC discharge amount with respect to the total HC adsorb amount is set by the HC discharge amount setting module 92, the HC adsorbing part temperature correction coefficient is calculated by the HC adsorbing part temperature correction coefficient calculating module so that the HC discharge amount per unit time becomes larger as the HC adsorbing part temperature becomes higher, and the exhaust gas pressure correction coefficient is calculated by the exhaust gas pressure coefficient calculating module 96 so that the correction coefficient becomes smaller as the exhaust gas pressure is higher. By multiplying the base value of the HC discharge amount by these correction coefficients, the HC discharge amount per unit time is calculated.

By calculating the HC discharge amount per unit time based on the total HC adsorb amount correlating with the HC discharge amount per unit time, the HC adsorbing part temperature, and the exhaust gas pressure, the calculation accuracy of HC discharge amount per unit time improves and accordingly, the false deterioration determination of the exhaust emission control catalyst due to the HC discharged from the HC adsorbing part can be prevented more surely.

In the first embodiment, the HC adsorbing part temperature which is the parameter used for the calculation of the HC discharge amount per unit time is estimated by the detection value of the exhaust-emission-control-catalyst downstream exhaust gas temperature sensor 44; however, the HC adsorbing part temperature may be the actual measured temperature of the HC adsorbing part, and may be estimated based on the exhaust gas temperature at the position upstream of the exhaust emission control catalyst correlating with the HC adsorbing part temperature, or alternatively, may be estimated based on the operating state of the engine. Moreover, to simplify the control, the HC adsorbing part temperature may be substituted by the parameter correlating with the HC adsorbing part temperature, such as the exhaust-emission-control-catalyst downstream exhaust gas temperature correlating with the HC adsorbing part temperature. Furthermore, in the first embodiment, in calculating the HC discharge amount per unit time, the base value of the HC discharge amount calculated based on the total HC adsorb amount which has the largest influence is multiplied by the HC adsorbing part temperature correction coefficient and the exhaust gas pressure correction coefficient to calculate the HC discharge amount per unit time; however, the base value of the HC discharge amount may be calculated based on either one of the HC adsorbing part temperature and the exhaust gas pressure and corrected by being multiplied by the correction coefficient regarding other kind of parameters, and the HC discharge amount per unit time may be calculated by using a map for the total HC adsorb amount, the HC adsorbing part temperature, and the exhaust gas pressure.

On the other hand, when the HC discharge amount is calculated with the method described above, it becomes important to accurately calculate the total HC adsorb amount. Thus, in the first embodiment, the total HC adsorb amount is calculated sequentially with the method in FIG. 8. FIG. 8 is a flowchart of a subroutine of calculating the total HC adsorb amount HCads. S32 and S33 are related to calculating an HC adsorbable ratio Ea. First, at S31, a current HC fill ratio RHC in the exhaust emission control catalyst is calculated based on a maximum HC adsorption capacity CTHC stored in the memory 122 in advance and a latest total HC adsorb amount also stored in the memory 122. Next, at S32, the exhaust gas temperature T1, the exhaust gas flow rate Vexh detected by an exhaust gas flow rate detecting module (described later), and the exhaust gas pressure Pexh obtained from the signal of the exhaust gas pressure sensor 37 are read, and the HC adsorbable ratio Ea is calculated at S33. Next, the calculation method of the HC adsorbable ratio Ea is described in detail with reference to FIG. 9.

FIG. 9 is a block diagram of a specific configuration regarding the HC adsorbable ratio Ea. The HC adsorbable ratio calculating module 91a includes an HC fill ratio calculating module 911, an HC adsorbable ratio setting module 912, the HC adsorbing part temperature detecting module 93, an HC adsorbing part temperature correction coefficient calculating module 913, the exhaust gas flow rate detecting module 71, an exhaust gas flow rate correction coefficient calculating module 914, the exhaust gas pressure detecting module 95, an exhaust gas pressure correction coefficient calculating module 915, and multiplying modules 916 to 918. The HC fill ratio calculating module 911 calculates the HC fill ratio based on the total HC adsorb amount calculated previously and the maximum HC adsorption capacity 123 stored in the memory 122. The HC adsorbable ratio setting module 912 receives a signal from the HC fill ratio calculating module 911 and sets a base value of the HC adsorbable ratio. The HC adsorbing part temperature detecting module 93 receives the signal from the exhaust-emission-control-catalyst downstream temperature sensor 44 and estimates the HC adsorbing part temperature. The HC adsorbing part temperature correction coefficient calculating module 913 receives the signal from the HC adsorbing part temperature detecting module 93 and calculates the HC adsorbing part temperature correction coefficient. The exhaust gas flow rate detecting module 71 receives the signals from the airflow sensor 32 and the engine speed sensor 39 and estimates the exhaust gas flow rate. The exhaust gas flow rate correction coefficient calculating module 914 receives the signal from the exhaust gas flow rate detecting module 71 and calculates the exhaust gas flow rate correction coefficient. The exhaust gas pressure detecting module 95 receives the signal from the exhaust gas pressure sensor 37 and detects the exhaust gas pressure at the entrance of the exhaust emission control catalyst. The exhaust gas pressure correction coefficient calculating module 915 receives the signal from the exhaust gas pressure detecting module 95 and calculates the exhaust gas pressure correction coefficient. The multiplying modules 916 to 918 multiply the base value of the HC adsorbable ratio, which is calculated by the HC adsorbable ratio setting module 912, by the correction coefficients calculated by the correction coefficient calculating modules 913 to 915, respectively. Thus, the latest value of the HC adsorbable ratio Ea is calculated, stored in the memory 122, and read at S33 in the flowchart of the total HC adsorb amount calculation in FIG. 8.

The HC adsorbable ratio Ea which is the ratio of an adsorbable HC amount with respect to the total HC amount supplied to the HC adsorbing part correlates with the total HC adsorb amount, the exhaust gas pressure, the HC adsorbing part temperature, and the exhaust gas flow rate. In other words, since the adsorption of HC is performed in a crystal portion where HC is not adsorbed, when the total HC adsorb amount is large, the crystal portion where HC is not adsorbed becomes small, and the HC adsorbable ratio becomes low. Moreover, as the HC adsorbing part temperature becomes higher, since HC becomes easier to be discharged as described above, HC becomes difficult to be adsorbed and the HC adsorbable ratio becomes lower. Moreover, as the exhaust gas flow rate becomes higher, since the flow speed of the exhaust gas becomes higher and the required time for HC discharged from the engine to pass through the HC adsorbing part becomes short, the HC adsorbable ratio becomes lower. Furthermore, as the exhaust gas pressure becomes higher, the pressure in the adsorbing part becomes higher and, thus, the boiling point at which HC is desorbed rises and HC becomes difficult to be discharged, which allows HC to be adsorbed more easily. Thus, the HC adsorbable ratio becomes higher. Therefore, as described above, the HC adsorbable ratio calculating module 91a calculates the HC adsorbable ratio to be higher as the total HC adsorb amount of the total HC adsorb amount calculating module becomes smaller, calculates the HC adsorbable ratio to be higher as the HC adsorbing part temperature of the HC adsorbing part temperature detecting module is lower, and calculates the HC adsorbable ratio to be higher as the exhaust gas pressure of the exhaust gas pressure detecting module becomes higher.

Specifically, by calculating the HC adsorbable ratio based on the total HC adsorb amount, the exhaust gas pressure, the HC adsorbing part temperature, and the exhaust gas flow rate correlating with the HC adsorbable ratio Ea, the HC adsorbable ratio is calculated more accurately. Accordingly, the total HC adsorb amount and the HC discharge amount are calculated more accurately; therefore, the more accurate oxidative reaction heat added by the HC discharged from the HC adsorbing part is taken into consideration, and the false deterioration determination of the exhaust emission control catalyst due to the HC discharged from the HC adsorbing part can be prevented more surely.

Note that the exhaust gas flow rate detecting module 71 performs the estimation based on the airflow sensor 32 and the engine speed sensor in the first embodiment; however, it may perform the estimation by using other parameter regarding the operating state of the engine (e.g., the injection amount of fuel by the injector 18), or by using an actually measured value obtained by a flow rate sensor. Moreover, in the first embodiment, in calculating the HC adsorbable ratio, the HC adsorbable ratio is calculated by multiplying the base value of the HC adsorbable ratio calculated based on the HC fill ratio having the largest influence by the HC adsorbing part temperature correction coefficient, the exhaust gas flow rate correction coefficient, and the exhaust gas pressure correction coefficient; however, it may be calculated by calculating the base value of the HC adsorbable ratio based on any one of the HC adsorbing part temperature, the exhaust gas flow rate, and the exhaust gas pressure, and multiplying the base value of the HC adsorbable ratio by using other parameter, or may be calculated by using a map for the HC fill ratio, the HC adsorbing part temperature, the exhaust gas flow rate, and the exhaust gas pressure.

The description returns to the flowchart of the subroutine of the total HC adsorb amount calculation in FIG. 8. After the adsorbable ratio Ea calculated with the method described above is read (S33), at S34, the HC discharge amount ΔHCdes per unit time calculated by the HC discharge amount calculating module 90 and the engine discharge HC amount ΔHCexh calculated by an engine discharge HC amount calculating module provided to the total HC adsorb amount calculating module 91 are read (S35), and an HC adsorb amount ΔHCads per unit time is calculated by an HC adsorb amount calculating module provided to the total HC adsorb amount calculating module 91 by subtracting the HC discharge amount ΔHCdes from a value obtained by multiplying the engine discharge HC amount ΔHCexh by the HC adsorbable ratio Ea (S36). Then, the total HC adsorb amount is updated by adding the HC adsorb amount ΔHCads per unit time to the previous total HC adsorb amount Hcads (S37), and by repeating the update until the IG is turned off, the total HC adsorb amount Hcads is calculated sequentially (S31 to S38). Moreover, when turning the IG off, HCads before turning the IG off is stored in the memory 122 (S39), so that when the engine is started next time, HCads_{—}1 stored in the memory 122 can set be set as the initial value of the total HC adsorb amount (S1 to S3 in FIG. 4).

Specifically, at S31 to S36, since ΔHCads is calculated based on the HC adsorbable ratio Ea, the engine discharge HC amount ΔHCexh, and the HC discharge amount ΔHCdes per unit time which influence the HC adsorb amount ΔHCads per unit time, the HC discharge amount ΔHCads per unit time and HCads, which is the integrated value of ΔHCads integrated by an HC adsorb amount integrating module provided to the total HC adsorb amount calculating module 91, is calculated more accurately, accordingly, the calculation accuracy of the HC discharge amounts per unit time improves, and the calculation accuracy of the diagnostic temperature parameter threshold Qdoc_in improves. Moreover, by storing, in the memory 122, ΔHCads immediately after the IG is turned off at S39, the total HC adsorb amount calculation error when the engine is started again can be reduced. In other words, when the engine is stopped before reaching the temperature at which HC is discharged, since HC remains adsorbed by the HC adsorbing part, the HC adsorb amount before the engine is stopped is stored at S39, and when the engine is started next time, the current total HC adsorb amount is calculated while the HC which is adsorbed before the engine is stopped is considered still remaining (S2). Therefore, an error of the total HC adsorb calculation value is reduced, and thus, the calculation accuracy of the total HC adsorb amount improves.

In other words, by using the exhaust emission control catalyst deterioration diagnosing method of the first embodiment, the false deterioration determination of the exhaust emission control catalyst due to the HC discharged from the HC adsorbing part can be prevented more surely.

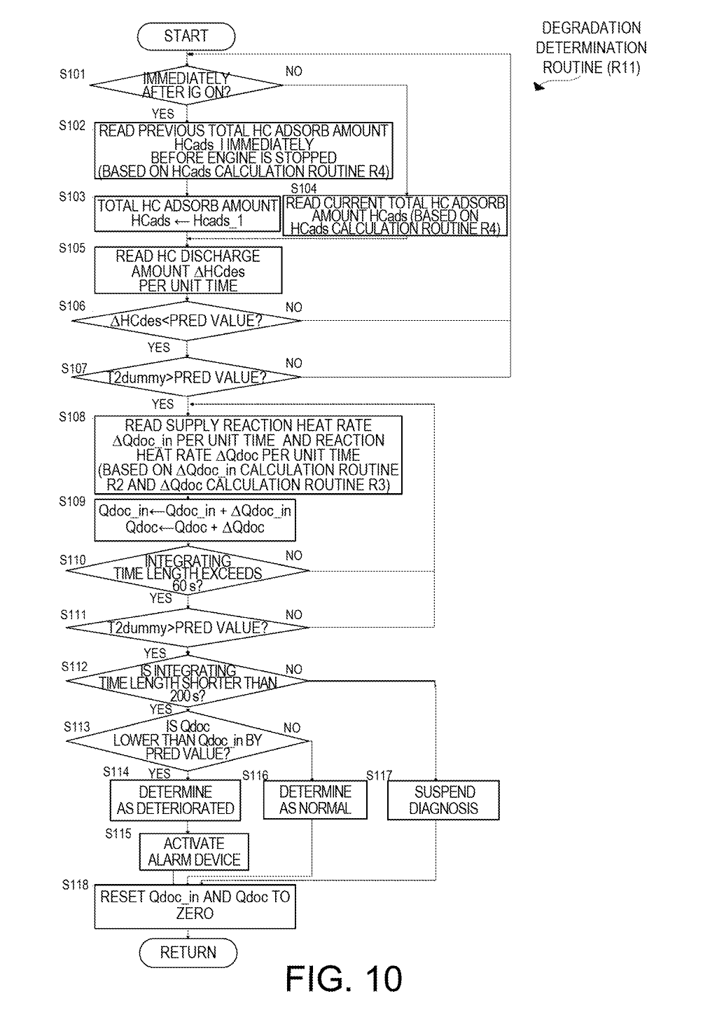

Next, an exhaust emission control catalyst deterioration diagnosing method of a second embodiment of the present invention is described with reference to FIG. 10. Note that the description overlapping with that in the first embodiment is omitted in the second embodiment. FIG. 10 is an overall flowchart (R11) of the exhaust emission control catalyst deterioration diagnosis of the second embodiment of the present invention. Similar to the first embodiment, the total HC adsorb amount HCads is set at S101 to S104. Next, at S105, the HC discharge amount ΔHCdes per unit time is read, at S106, whether ΔHCdes is smaller than a predetermine value is determined, and if it is lower than the predetermined value, the control proceeds to S107; whereas if it is not lower than the predetermined value, the diagnostic condition is considered as not met and the flow returns back to S1. In other words, in the second embodiment, by performing the diagnosis when the HC discharge amount per unit time is smaller than the predetermined value and the adding amount of the oxidative reaction heat in the exhaust emission control catalyst produced by the HC discharged from the HC adsorbing part is sufficiently small, the diagnosis is performed while excluding the influence of the adding amount of the oxidative reaction heat by the HC discharged from the HC adsorbing part. With such a configuration, the false deterioration determination of the exhaust emission control catalyst due to the HC discharged from the HC adsorbing part can be prevented. Specifically, in the second embodiment, a module that performs the control at S106, where the performability of the deterioration determination is determined based on ΔHCdes, corresponds to the false deterioration determination preventing module for preventing the deterioration determining module from performing false determinations because of the increase of the actual exhaust-emission-control-catalyst temperature parameter which is caused by the increase of the HC discharge amount.

Sequentially, at S107, same as the first embodiment, whether the exhaust-emission-control-catalyst downstream exhaust gas estimated temperature T2dummy in the dummy catalyst is higher than a predetermined value (e.g., 160° C. or higher) is determined, and if T2dummy is higher than the predetermined value, the diagnostic condition is considered as met and the control proceeds to S8; whereas, if T2dummy is not higher than the predetermined value, the diagnostic condition is considered as not met and the flow returns back to S1.

Next, at S108, the latest value of ΔQdoc_in calculated and stored in the subroutine of FIG. 5 is added to Qdoc_in which is previously calculated, and the latest value of ΔQdoc calculated and stored in the subroutine of FIG. 6 is added to Qdoc previously calculated, so as to update Qdoc_in and Qdoc. Then, the update is repeated until the integrated time length exceeds 60 s (S108 to S110). Note that in the second embodiment, since the diagnosis is performed when the HC discharge amount is sufficiently small, the reading of the HC discharge amount per unit time at S914 in the subroutine of calculating Qdoc_in in FIG. 5, and the adding of the HC discharge amount per unit time in the calculation of the total HC supply amount per unit time at 5915 may be omitted to simplify the control.

Sequentially, at S111, whether T2dummy is higher than the predetermined value is determined, and if it is higher than the predetermined value, the control proceeds to S112; whereas, if it is not higher than the predetermined value, the integrations of respectively Qdoc_in and Qdoc are repeated. At S112, whether the integrating time length is shorter than 200 s is determined, and if it is shorter than 200 s, the control proceeds to S113; whereas, if it is not shorter than 200 s, the timing is considered as not suitable for the diagnosis and the control proceeds to S117 where the diagnosis is suspended.

Next, at S113, whether Qdoc is lower than Qdoc_in by a predetermined amount is determined, and if it is lower by the predetermined amount, the oxidative reaction in the exhaust emission control catalyst is considered to be too low and the deterioration of the exhaust emission control catalyst is determined (S114), and the alarm device is activated (S115). On the other hand, if it is not lower by the predetermined amount, the oxidative reaction in the exhaust emission control catalyst is determined to be sufficient and the exhaust emission control catalyst is determined as not deteriorated (S116). After the deterioration determination is completed, the latest values of Qdoc_in and Qdoc are reset to zero (S118).

In other words, by using the exhaust emission control catalyst deterioration diagnosing method of the second embodiment, the false deterioration determination of the exhaust emission control catalyst due to the HC discharged from the HC adsorbing part is prevented more accurately.

As described above, in the deterioration diagnosis of the exhaust emission control catalyst including the HC adsorbing part, since the false deterioration determination due to the HC discharged from the HC adsorbing part can be prevented, and therefore, in the fields of method and system for diagnosing deterioration of exhaust emission control catalysts provided in exhaust passages of engines, particularly oxidation catalysts including HC adsorbing parts, the present invention can suitably be used.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

### DESCRIPTION OF REFERENCE CHARACTERS

1 Diesel Engine
10 PCM
32 Airflow Sensor
34 Intake Pressure Sensor
35 Intake Air Temperature Sensor
36 Fluid Temperature Sensor
37 Exhaust Gas Pressure Sensor
39 Engine Speed Sensor (Crank Angle Sensor)
40 Exhaust Passage
41 Exhaust Emission Control Catalyst (Oxidation Catalyst)
41a Carrier
41b Oxidation Catalyst Part
41c HC Adsorbing Part
42 Diesel Particulate Filter (DPF)
43 Exhaust-Emission-Control-Catalyst Upstream Exhaust Gas Temperature Sensor
44 Exhaust-Emission-Control-Catalyst Downstream Exhaust Gas Temperature Sensor
45 DPF Pressure Difference Sensor
46 Linear O₂ Sensor
71 Exhaust Gas Flow Rate Detecting Module
80 Actual Exhaust-Emission-Control-Catalyst Temperature Parameter Detecting Module
90 HC Discharge Amount Calculating Module
91 Total HC Adsorb Amount Calculating Module
91a HC Adsorbable Ratio Calculating Module
93 HC Adsorbing Part Temperature Detecting Module
95 Exhaust Gas Pressure Detecting Module
100 Diagnostic Temperature Parameter Threshold Setting Module
110 Deterioration Determining Module
121 CPU
122 Memory
130 Alarm Device

What is claimed is:

1. A deterioration diagnosing system for an exhaust emission control catalyst of an engine, the exhaust emission control catalyst including an HC (carbon hydride) adsorbing part and an oxidation catalyst part, the HC adsorbing part disposed in an exhaust passage of the engine and for adsorbing HC within exhaust gas when a temperature of the HC adsorbing part is lower than an HC dischargeable temperature and discharging the adsorbed HC when the temperature of the HC adsorbing part is higher than the HC dischargeable temperature, the oxidation catalyst part for purifying, by oxidation, the HC discharged from the HC adsorbing part and the HC within the exhaust gas under a high temperature, the system comprising:
an actual exhaust-emission-control-catalyst temperature parameter detecting module for detecting a parameter correlating with an actual temperature of the exhaust emission control catalyst;
a deterioration determining module for receiving a detection value from the actual exhaust-emission-control-catalyst temperature parameter detecting module when predetermined diagnosis executing conditions are met, and determining that the exhaust emission control catalyst is deteriorated when the detection value is smaller than a predetermined diagnostic temperature parameter threshold;
an HC discharge amount calculating module for calculating an amount of discharging HC from the HC adsorbing part; and
a false deterioration determination preventing module for receiving a signal from the HC discharge amount calculating module and preventing false determination of the deterioration determining module that is induced by an increase of the actual exhaust-emission-control-catalyst temperature parameter associated with an increase of the HC discharge amount.

2. The system of claim 1, wherein the HC discharge amount calculating module includes a total HC adsorb amount calculating module for calculating a total amount of HC adsorbed by the HC adsorbing part, and calculates the HC discharge amount to be larger as the total HC adsorb amount calculated by the total HC adsorb amount calculating module is larger.

3. The system of claim 1, wherein the HC discharge amount calculating module includes an HC adsorbing part temperature detecting module for detecting a temperature of the HC adsorbing part, and calculates the HC discharge amount to be larger as the HC adsorbing part temperature detected by the HC adsorbing part temperature detecting module is higher.

4. The system of claim 1, wherein the HC discharge amount calculating module includes an exhaust gas pressure detecting module for detecting a pressure of the exhaust gas discharged from the engine, and calculates the HC discharge amount to be larger as the exhaust gas pressure detected by the exhaust gas pressure detecting module is lower.

5. The system of claim 1, wherein the HC discharge amount calculating module includes:
a total HC adsorb amount calculating module for calculating a total amount of HC adsorbed by the HC adsorbing part, and calculates the HC discharge amount to be larger as the total HC adsorb amount calculated by the total HC adsorb amount calculating module is larger; and
an HC adsorbing part temperature detecting module for detecting a temperature of the HC adsorbing part, and calculates the HC discharge amount to be larger as the HC adsorbing part temperature detected by the HC adsorbing part temperature detecting module is higher; and
an exhaust gas pressure detecting module for detecting a pressure of the exhaust gas discharged from the engine, and calculates the HC discharge amount to be larger as the exhaust gas pressure detected by the exhaust gas pressure detecting module is lower.

6. The system of claim 2, wherein the total HC adsorb amount calculating module includes:
an engine discharge HC amount calculating module for calculating an HC amount discharged from the engine per unit time;
an HC adsorbable ratio calculating module for calculating an HC adsorbable ratio in the HC adsorbing part;
an HC adsorb amount calculating module for calculating an HC adsorb amount per unit time based on the HC amount discharged from the engine calculated by the engine discharge HC amount calculating module and the HC adsorbable ratio; and
an HC adsorb amount integrating module for integrating the HC adsorb amounts calculated by the HC adsorb amount calculating module,
wherein the HC discharge amount calculating module calculates the integrated value obtained by the HC adsorb amount integrating module as a total amount of HC adsorbed by the HC adsorbing part.

7. The system of claim 6, wherein the HC adsorbable ratio calculating module calculates the HC adsorbable ratio to be higher as the total HC adsorb amount calculated by the total HC adsorb amount calculating module is smaller.

8. The system of claim 6, wherein the HC adsorbable ratio calculating module includes an HC adsorbing part temperature detecting module for detecting a temperature of the HC adsorbing part, and calculates the HC adsorbable ratio to be higher as the HC adsorbing part temperature detected by the HC adsorbing part temperature detecting module is lower.

9. The system of claim 6, wherein the HC adsorbable ratio calculating module includes an exhaust gas flow rate detecting module for detecting a flow rate of the exhaust gas discharged from the engine, and calculates the HC adsorbable ratio to be higher as the exhaust gas flow rate detected by the exhaust gas flow rate detecting module is smaller.

10. The system of claim 6, wherein the HC adsorbable ratio calculating module includes an exhaust gas pressure detecting module for detecting a pressure of the exhaust gas discharged from the engine, and calculates the HC adsorbable ratio to be higher as the exhaust gas pressure detected by the exhaust gas pressure detecting module is larger.

11. The system of claim 6, wherein the HC adsorbable ratio calculating module calculates the HC adsorbable ratio to be higher as the total HC adsorb amount calculated by the total HC adsorb amount calculating module is smaller,
wherein the HC adsorbable ratio calculating module includes:
an HC adsorbing part temperature detecting module for detecting a temperature of the HC adsorbing part;
an exhaust gas flow rate detecting module for detecting a flow rate of the exhaust gas discharged from the engine; and
an exhaust gas pressure detecting module for detecting a pressure of the exhaust gas discharged from the engine,
wherein the HC adsorbable ratio calculating module calculates the HC adsorbable ratio to be higher as the HC adsorbing part temperature detected by the HC adsorbing part temperature detecting module is lower,
wherein the HC adsorbable ratio calculating module calculates the HC adsorbable ratio to be higher as the exhaust gas flow rate detected by the exhaust gas flow rate detecting module is smaller, and
wherein the HC adsorbable ratio calculating module calculates the HC adsorbable ratio to be higher as the exhaust gas pressure detected by the exhaust gas pressure detecting module is larger.

12. The system of claim 2, wherein the total HC adsorb amount calculating module includes a total HC adsorb amount memory for storing the total HC adsorb amount calculated immediately before the engine is stopped, and sets the stored value in the total HC adsorb amount memory as the total HC adsorb amount when the engine is restarted.

13. The system of claim 1, wherein the false deterioration determination preventing module includes a diagnostic temperature parameter threshold setting module for setting the predetermined diagnostic temperature parameter threshold, and controls the diagnostic temperature parameter threshold setting module to change the predetermined diagnostic temperature parameter threshold to be higher as the HC discharge amount calculated by the HC discharge amount calculating module is larger.

14. The system of claim 13, wherein:
the HC discharge amount calculating module includes:
an engine discharge HC amount calculating module for calculating an HC amount discharged from the engine; and
a total HC supply amount calculating module for calculating a total HC supply amount to be supplied to the exhaust emission control catalyst based on the HC amount discharged from the engine calculated by the engine discharge HC amount calculating module and the HC discharge amount calculated by the HC discharge amount calculating module;
the diagnostic temperature parameter threshold setting module includes a reaction heat calculating module for calculating a reaction heat rate produced in the exhaust emission control catalyst when the total HC supply amount is supplied to the exhaust emission control catalyst, and
the diagnostic temperature parameter threshold setting module sets the predetermined diagnostic temperature parameter threshold based on the reaction heat rate.

15. The system of claim 14, wherein the diagnostic temperature parameter threshold setting module includes an engine discharge CO amount calculating module for calculating an amount of CO discharged from the engine,
wherein the reaction heat calculating module calculates the reaction heat rate produced in the exhaust emission control catalyst when the total HC supply amount and the calculated engine discharge CO amount are supplied to the exhaust emission control catalyst, and the diagnostic temperature parameter threshold setting module sets the diagnostic temperature parameter threshold based on the reaction heat rate.

16. The system of claim 1, wherein when the HC discharge amount is larger than a predetermined value, the false deterioration determining module restricts the deterioration determination performed by the deterioration determining module.

17. A method of determining deterioration of an exhaust emission control catalyst including an HC adsorbing part and an oxidation catalyst part, the HC adsorbing part disposed in an exhaust passage of an engine and for adsorbing HC within exhaust gas when a temperature of the HC adsorbing part is lower than an HC dischargeable temperature and discharging the adsorbed HC when the temperature of the HC adsorbing part is higher than the HC dischargeable temperature, the oxidation catalyst part for purifying, by oxidation, the HC discharged from the HC adsorbing part and the HC within the exhaust gas under a high temperature, the method comprising:
detecting an actual exhaust-emission-control-catalyst temperature parameter correlating with an actual temperature of the exhaust emission control catalyst;
calculating an amount discharging HC from the HC adsorbing part;
setting a diagnostic temperature parameter threshold of the exhaust emission control catalyst based on the HC discharge amount; and
determining that the exhaust emission control catalyst is deteriorated when the actual exhaust-emission-control-catalyst temperature parameter is lower than the diagnostic temperature parameter threshold by a predetermined value.
